(19) United States
(12) Patent Application Publication
(10) Pub. No.: US 2022/0184795 A1
(43) Pub. Date: Jun. 16, 2022

(54) EXTENDABLE CLEANING TOOL

(71) Applicant: UNGER MARKETING INTERNATIONAL, LLC, Bridgeport, CT (US)

(72) Inventors: William Harrington, Newtown, CT (US); Kai Hirsch, Cologne (DE); Cristian Siems, Westphalia (DE); Stephen P. Huda, Shelton, CT (US); Joseph K. Patterson, Monroe, CT (US)

(21) Appl. No.: 17/684,941

(22) Filed: Mar. 2, 2022

Related U.S. Application Data
(63) Continuation of application No. PCT/US2021/057180, filed on Oct. 29, 2021.
(60) Provisional application No. 63/107,576, filed on Oct. 30, 2020.

(51) Int. Cl. B25G 1/04; A47L 13/46; A47L 13/22; A47L 13/16

(52) U.S. Cl. CPC B25G 1/04; A47L 13/46; A47L 13/254; A47L 13/16; A47L 13/22

(57) ABSTRACT

Extendable cleaning tools are described. The tools include a plurality of pole elements, wherein the plurality of pole elements include an innermost pole element and an outermost pole element, wherein the innermost pole element is moveable relative to the outermost pole element in an axial direction and the innermost pole element and the outermost pole element are not rotatable relative to each other, a clamp arranged at an end of the outermost pole element and configured to selectively engage with a pole element of the plurality of pole elements arranged within the outermost pole element, and a working head assembly attached to an end of the innermost pole element.

### CROSS-REFERENCE TO RELATED APPLICATION

This application is a Continuation of International Application No. PCT/US2021/057180, filed Oct. 29, 2021, which claims the benefit of U.S. Provisional Application Ser. No. 63/107,576, filed Oct. 30, 2020, the disclosures of which are incorporated herein by reference in their entireties.

### BACKGROUND

The subject matter disclosed herein generally relates to extendable poles and, more particularly, to extendable cleaning tools.

For buildings and tall structures, it is often necessary to ensure the outside facade and surfaces remain clean. Such cleaning can ensure an aesthetic standard of the structure. Further, particularly with respect to glass surfaces (e.g., windows, solar panels, etc.), such cleaning can ensure desired thermal and optical performance of the glass (e.g., letting light and/or heat into an interior space, improved solar cell performance, etc.). A dirty glass surface may lead to reduced transmission of light therethrough, potentially increasing lighting costs (e.g., increased electrical costs). Furthermore, a dirty glass surface may also lead to increased heat absorption by the dirty particles adhered to the glass. Such particulates absorbing and retaining heat can leading to an increase in costs associated with air conditioning systems.

Accordingly, devices that enable cleaning of such exterior surfaces, and in particular glass surfaces, are useful. One solution is the use of poles, which may be extendable, to enable a user to reach locations or surfaces that are distant but without require extensive movement or tools to reach such locations or surfaces (e.g., harnesses, ladders, cradles, etc.). An extendable cleaning pole may be extended upward from the ground. The pole may be configured to support and/or supply cleaning fluid to a brush or other cleaning implement on an upper end of the pole. Such cleaning systems and/or tools can include telescopically extending poles and/or modular poles and a cleaning head (e.g., brush and/or squeegee) at one end of the pole. Cleaning fluid typically flows through a tube running within or along an exterior of the telescopically extending pole to the cleaning head.

### SUMMARY

According to some embodiments, extendable cleaning tools are provided. The extendable cleaning tools include a plurality of pole elements, wherein the plurality of pole elements include an innermost pole element and an outermost pole element, wherein the innermost pole element is moveable relative to the outermost pole element in an axial direction and the innermost pole element and the outermost pole element are not rotatable relative to each other. A clamp is arranged at an end of the outermost pole element and configured to selectively engage with a pole element of the plurality of pole elements arranged within the outermost pole element. A working head assembly attached to an end of the innermost pole element.

In addition to one or more of the features described herein, or as an alternative, further embodiments of the extendable cleaning tools may include that the plurality of pole elements includes a plurality of nested pole elements arranged within the outermost pole element.

In addition to one or more of the features described herein, or as an alternative, further embodiments of the extendable cleaning tools may include that the working head assembly includes a pole connector configured to engage with the innermost pole element and a head connector configured to engage with a working head.

In addition to one or more of the features described herein, or as an alternative, further embodiments of the extendable cleaning tools may include that the working head is a water-fed working head.

In addition to one or more of the features described herein, or as an alternative, further embodiments of the extendable cleaning tools may include that the pole connector includes a circular connector and a non-circular connector.

In addition to one or more of the features described herein, or as an alternative, further embodiments of the extendable cleaning tools may include that the head connector includes a pivot portion and a connector portion, wherein the pivot portion is configured to pivotally attach to the innermost pole element and the connector portion is configured to attach to a working head.

In addition to one or more of the features described herein, or as an alternative, further embodiments of the extendable cleaning tools may include that the pivot portion and the connector portion are releasably attachable with each other.

In addition to one or more of the features described herein, or as an alternative, further embodiments of the extendable cleaning tools may include that the connector portion may be rotated relative to the pivot portion about a head connector axis.

In addition to one or more of the features described herein, or as an alternative, further embodiments of the extendable cleaning tools may include that the connector portion includes a polygonal bore and the pivot portion includes a polygonal base, wherein the polygonal bore and the polygonal base are configured to enable rotation about the head connector axis in a fixed manner.

In addition to one or more of the features described herein, or as an alternative, further embodiments of the extendable cleaning tools may include that the connector portion includes a connector rotational axis such that an attached working head is rotatable about the connector rotational axis.

In addition to one or more of the features described herein, or as an alternative, further embodiments of the extendable cleaning tools may include that the connector portion includes a locking element configured to secure the attached working head about the connector rotational axis.

In addition to one or more of the features described herein, or as an alternative, further embodiments of the extendable cleaning tools may include that the clamp includes a lever and an adjustment knob that are engageable and configured to open or close the clamp from engagement with the pole element of the plurality of pole elements arranged within the outermost pole element.

In addition to one or more of the features described herein, or as an alternative, further embodiments of the extendable cleaning tools may include that a biasing element is arranged between the lever and the adjustment knob, the biasing element configured to generate an opening biasing force.

In addition to one or more of the features described herein, or as an alternative, further embodiments of the extendable cleaning tools may include that the clamp defines a bore therethrough with a first portion configured to engage the outermost pole and a second portion configured to selectively engage with the pole element of the plurality of pole elements arranged within the outermost pole element.

In addition to one or more of the features described herein, or as an alternative, further embodiments of the extendable cleaning tools may include that the clamp includes at least one pole grip, the pole grip being formed of thermoplastic rubber or thermoplastic elastomer.

In addition to one or more of the features described herein, or as an alternative, further embodiments of the extendable cleaning tools may include that the at least one pole grip is integrally formed with the clamp from a single mold.

In addition to one or more of the features described herein, or as an alternative, further embodiments of the extendable cleaning tools may include that each pole element of the plurality of pole elements has a non-circular cross-sectional geometry.

In addition to one or more of the features described herein, or as an alternative, further embodiments of the extendable cleaning tools may include that each pole element of the plurality of pole elements includes at least two lobes, wherein each lobe is a continuous curved structure of the material of the respective pole element having a constant radius of curvature.

In addition to one or more of the features described herein, or as an alternative, further embodiments of the extendable cleaning tools may include that each pole element of the plurality of pole elements includes three lobes, wherein each lobe is a continuous curved structure of the material of the respective pole element having a constant radius of curvature.

In addition to one or more of the features described herein, or as an alternative, further embodiments of the extendable cleaning tools may include that two adjacent lobes of the three lobes are connected by an intermediate section, wherein the intermediate section has a different curvature than either of the two connected lobes.

In addition to one or more of the features described herein, or as an alternative, further embodiments of the extendable cleaning tools may include a pole extension adapter configured to attach to the outermost pole at an end opposite the end engageable with the working head assembly, wherein the pole extension adapter is configured to connect at least one additional pole element to the outermost pole.

In addition to one or more of the features described herein, or as an alternative, further embodiments of the extendable cleaning tools may include that the pole extension adapter defines a channel configured to allow a hose to pass from an exterior area to within the outermost pole element at a location between the outermost pole element and the at least one additional pole element.

In addition to one or more of the features described herein, or as an alternative, further embodiments of the extendable cleaning tools may include that the working head assembly includes a working head.

In addition to one or more of the features described herein, or as an alternative, further embodiments of the extendable cleaning tools may include that the working head includes a brush.

In addition to one or more of the features described herein, or as an alternative, further embodiments of the extendable cleaning tools may include that the working head assembly includes a pole connector, a first extension element, and a head connector, wherein the first extension element is connected between the pole connector and the head connector.

In addition to one or more of the features described herein, or as an alternative, further embodiments of the extendable cleaning tools may include a second extension element arranged between one of the pole connector and the first extension element or between the first extension element and the head connector.

In addition to one or more of the features described herein, or as an alternative, further embodiments of the extendable cleaning tools may include that at least one of the pole connector, the first extension element, and the head connector is pivotable with respect to a connected component.

According to some embodiments, extendable cleaning tool kits are provided. The extendable cleaning tool kits include a pole connector, a first extension element, a second extension element, and a head connector having a circular connector and a non-circular connector configured to selectively connect to a pole element. The pole connector is selectively connectable to each of the first extension element, the second extension element, and the head connector, the head connector is selectively connectable to each of the first extension element and the second extension element, and the first extension element is selectively connectable to the second extension element.

In addition to one or more of the features described herein, or as an alternative, further embodiments of the extendable cleaning tool kits may include one or more internal hose structures arranged within each of the pole connector, the first extension element, the second extension element, and the head connector.

In addition to one or more of the features described herein, or as an alternative, further embodiments of the extendable cleaning tool kits may include one or more hose connectors configured to enable selective fluid connection between hose structures of the pole connector, the first extension element, the second extension element, and the head connector.

In addition to one or more of the features described herein, or as an alternative, further embodiments of the extendable cleaning tool kits may include that each of the pole connector, the first extension element, the second extension element, and the head connector are selectively connectable to each other.

In addition to one or more of the features described herein, or as an alternative, further embodiments of the extendable cleaning tool kits may include that the selective connection is a pivotable connection.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of an extendable cleaning tool in accordance with an embodiment of the present disclosure;

FIG. 1B is an alternative view of the extendable cleaning tool of FIG. 1A;

FIG. 1C is an exploded view of a portion of the extendable cleaning tool of FIG. 1A;

FIG. 2A is a schematic illustration of a pole extension adapter in accordance with an embodiment of the present disclosure;

FIG. 2B is a schematic illustration of the pole extension adapter of FIG. 2A having a fluid conduit arranged therein;

FIG. 2C is a schematic illustration of the pole extension adapter of FIG. 2A as arranged between two pole elements;

FIG. 3A is a schematic illustration of a portion of a pole element in accordance with an embodiment of the present disclosure;

FIG. 3B is an end-on illustration of the pole element of FIG. 3A;

FIG. 4A is an elevation view of a clamp in accordance with an embodiment of the present disclosure;

FIG. 4B is a top-down view of the clamp of FIG. 4A;

FIG. 4C is a side view of the clamp of FIG. 4A;

FIG. 4D is an isometric illustration of the clamp of FIG. 4A;

FIG. 5 is a schematic illustration of a clamp in accordance with an embodiment of the present disclosure;

FIG. 6 is a schematic illustration of a portion of a clamp in accordance with an embodiment of the present disclosure;

FIG. 7A illustrates a working head assembly in accordance with an embodiment of the present disclosure, in a first configuration;

FIG. 7B illustrates the working head assembly of FIG. 7A in a second configuration having an extension element;

FIG. 7C illustrates the working head assembly of FIG. 7A in a third configuration having two extension elements;

FIG. 8A is a schematic illustration of a pole connector in accordance with an embodiment of the present disclosure;

FIG. 8B is a side view illustration of the pole connector of FIG. 8A;

FIG. 9A is a schematic illustration of a head connector in accordance with an embodiment of the present disclosure;

FIG. 9B illustrates the head connector of FIG. 9A with the components thereof separated;

FIG. 9C illustrations a view of a pivot portion of the head connector of FIG. 9A;

FIG. 9D illustrates a connector portion of the head connector of FIG. 9A;

FIG. 9E illustrates a connector portion of the head connector and movement directions enabled thereby in accordance with an embodiment of the present disclosure;

FIG. 10 is a schematic illustration of a head connector in accordance with an embodiment of the present disclosure;

FIG. 11 is a schematic illustration of a portion of a working head assembly in accordance with an embodiment of the present disclosure;

FIG. 12 is a schematic illustration of a kit of a working head assembly in accordance with an embodiment of the present disclosure;

FIG. 13A is a schematic illustration of an extendable cleaning tool in accordance with an embodiment of the present disclosure;

FIG. 13B is an enlarged illustration of the extendable cleaning tool of FIG. 13A;

FIG. 13C is an exploded view of a portion of the extendable cleaning tool of FIG. 13A;

FIG. 14A is a schematic illustration of a pole extension adapter in accordance with an embodiment of the present disclosure;

FIG. 14B is a schematic illustration of the pole extension adapter of FIG. 14A as attached at the end of a pole element;

FIG. 14C is a schematic illustration of the pole extension adapter of FIG. 14A as arranged between two pole elements;

FIG. 15 is a schematic illustration of a portion of a working head assembly in accordance with an embodiment of the present disclosure;

FIG. 16A is a schematic illustration of a connection assembly for an extendable cleaning tool in accordance with an embodiment of the present disclosure;

FIG. 16B is a schematic illustration of the connection assembly of FIG. 16A with the components separated;

FIG. 16C is a side view of the connection assembly of FIG. 16A;

FIG. 17 is a schematic illustration of another connection assembly with anti-rotation and joining features in accordance with embodiments of the present disclosure;

FIG. 18 is a schematic illustration of another connection assembly with anti-rotation and joining features in accordance with embodiments of the present disclosure;

FIG. 19A is a schematic illustration of a handle attached to a pole element in accordance with an embodiment of the present disclosure;

FIG. 19B is a schematic illustration of the handle of FIG. 19A as not attached to a pole element;

FIG. 19C is a side elevation schematic of the handle of FIG. 19A;

FIG. 20A is a schematic illustration of part of an anti-rotation configuration for extendable cleaning tools in accordance with an embodiment of the present disclosure; and

FIG. 20B is another schematic illustration of the anti-rotation configuration for extendable cleaning tools of FIG. 20A.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

As discussed above, cleaning tools may include extendable elements or poles configured to enable a user to reach locations or surfaces that are distant without requiring extensive movement or tools to reach such locations or surfaces. The cleaning pole may be configured to support and/or supply cleaning fluid to a brush on an upper end of the pole or directly to an adjacent surface (e.g., glass surface, such as windows, solar panels, glass ceiling/roof sections, etc.). In some configurations, a hose may be supported along an exterior of the pole from a fluid source to a working head (e.g., brush or squeegee). In other configurations, a hose may be configured to pass through an interior channel or bore of the pole and connect to the working head. Further, in other configurations, the pole itself may define an interior channel or passage for fluid to be conveyed to the working head. Any of such cleaning poles can include a telescopically extending pole structure and/or a modular extending pole structure with different segments and/or pole elements removably connected to each other.

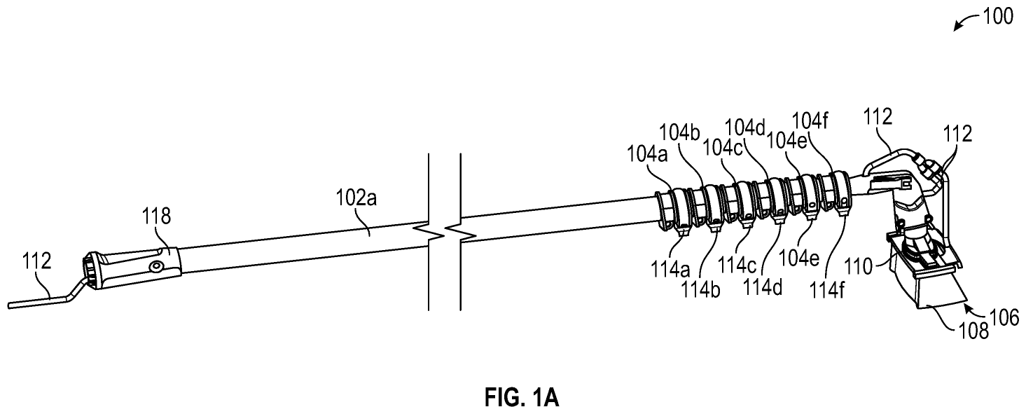

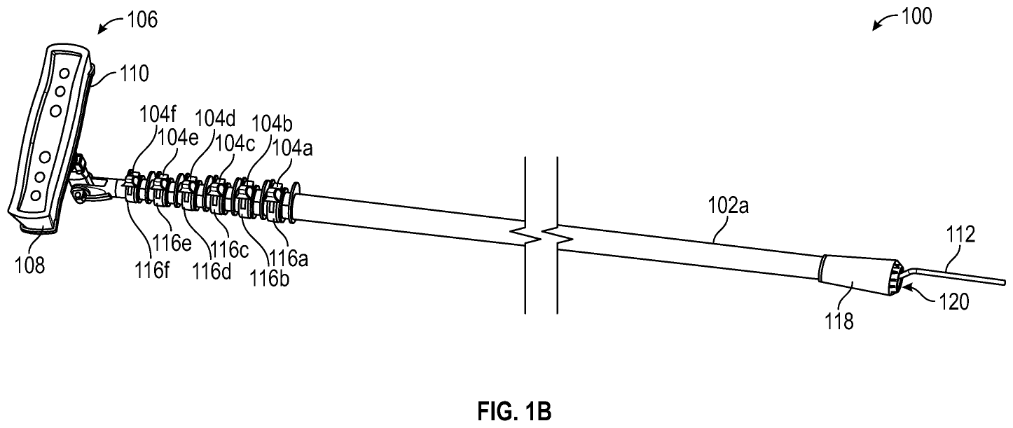

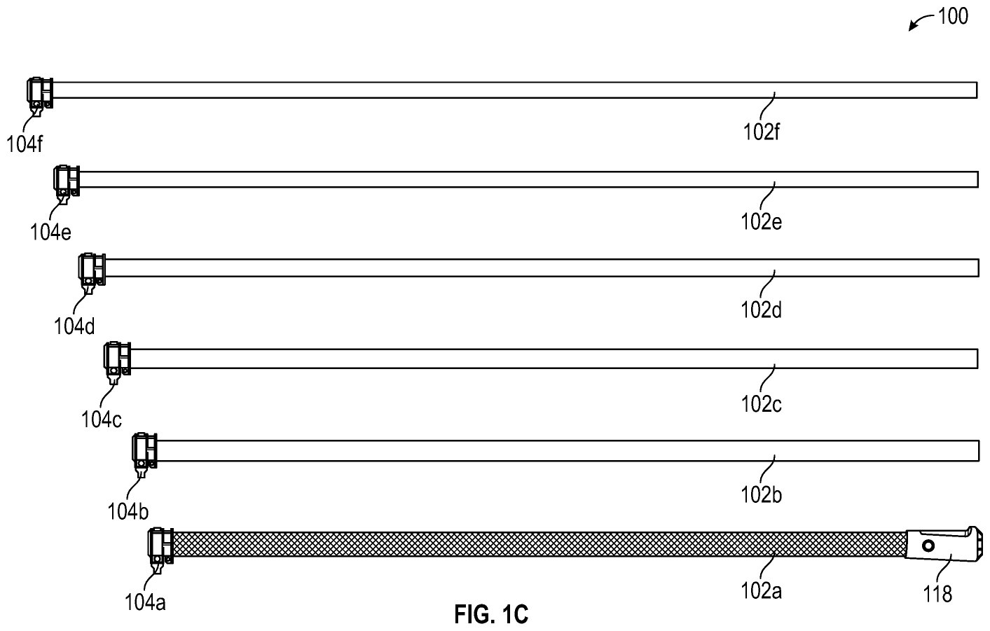

Referring to FIGS. 1A-1C, schematic illustrations of an extendable cleaning tool 100 in accordance with an embodiment of the present disclosure are shown. FIG. 1A is a side schematic illustration of the extendable cleaning tool 100, FIG. 1B is a bottom schematic illustration of the extendable cleaning tool 100, and FIG. 1C is an unassembled illustration showing portions of the extendable cleaning tool 100. The extendable cleaning tool 100, as shown, is a telescoping pole configuration that incorporates nested pole elements that are selectively engageable with each other to allow for customizable tool lengths and/or extension. In other configurations, rather than telescoping, the pole elements may be joinable or connectable by various engagement mechanisms, as will be appreciated by those of skill in the art.

As shown in FIGS. 1A-1C, the extendable cleaning tool 100 includes pole elements 102a-102f which are nested within each other to form an extendable and telescoping pole configuration. Each pole element 102a-102f includes a respective clamp 104a-104f on an end thereof. The clamps 104a-104f are configured to provided selective fixed engagement between an outer pole element and an inner pole element of the pole elements 102a-102f, which allows for the telescoping nature of the extendable cleaning tool 100. At one end of the extendable cleaning tool 100, and attached to an innermost pole element 102f, is a working head assembly 106. As used herein, the “innermost” pole is disposed substantially radially inward from, or disposed within, the next adjacent pole when the extendable cleaning tool is in a collapsed state (e.g., pole element 102e). The working head assembly 106 may selectively engage and be attached to the innermost pole element 102f by an associated clamp 104f of the innermost pole element 102f.

The working head assembly 106, as shown, has a brush configuration, including a brush 108, a head mount 110, and one or more fluid conduits 112. The brush 108 may incorporate one or more types or sets of bristles configured to enable scrubbing of a surface, such as a glass surface or wall. In other embodiments, the brush 108 may be replaced with a sponge, squeegee, mop head, or other cleaning implement as will be appreciated by those of skill in the art. The pole elements 102a-102f are hollow. The hollow interior of each pole element 102a-102f enables the nesting of the pole elements 102a-102f and also enables, in some embodiments, the fluid conduit 112, or other hose or similar structure, to be passed therethrough and fluidly connect to the fluid conduit 112 of the working head assembly 106. Such fluid conduit 112 can connect the working head assembly 106 to a fluid supply source, such as a faucet, filtered water device, or other fluid supply as will be appreciated by those of skill in the art. In some embodiments, the fluid conduit 112 can be used for a water-fed working head assembly 106, which provides liquids (e.g. water or a cleaning solution) directly into or at the brush 108 or other attached cleaning implement. In some embodiments, the hollow interior of the pole elements 102a-102f may define a fluid conduit that does not require a separate hose passed therethrough. Further, in some embodiments, a hose or other conduit structure may be supported along an exterior of the extendable cleaning tool 100 by optional guides 114a-114f, which are part of or connected to the respective clamps 104a-104f.

As shown in FIG. 1B, each clamp 104a-104f includes a manual actuator element 116a-116f. The manual actuator elements 116a-116f enable a user to loosen an engagement between one pole element 102a-102f and another pole element 102a-102f, to allow two of the pole elements 102a-102f to translate, slide, or otherwise move in an axial direction relative to each other in order to increase or decrease a total length of the extendable cleaning tool 100. The clamps 104a-104f are configured to provide pressure or friction engagement between one pole element 102a-102f and another pole element 102a-102f. The clamps 104a-104f, in isolation, may define internal apertures through which an associated pole element 102a-102f may be installed and attached. In some embodiments, the clamps 104a-104f may include at least one element that is actuated by the manual actuator elements 116a-116f to pass through a respective pole element 102a-102f to engage with another pole element 102a-102f that is interior to the respective pole element 102a-102f

An outermost pole element 102a includes a base 118. The base 118 of the outermost pole element 102a may be arranged as a handle for manual gripping and holding of the extendable cleaning tool 100. The base 118 may also include, as shown in FIG. 1B, an opening 120. The opening 120 may be configured to receive a hose, tube, or other fluid conduit structure (e.g., fluid conduit 112), and guide such hose, tube, or other fluid conduit structure into and through an interior hollow of the pole elements 102a-102f of the extendable cleaning tool 100 to the working head assembly 106. The base 118 of the pole element 102a may also be configured to receive a pole extension assembly in order to enable extension of the extendable cleaning tool 100 beyond the length provided by the extendable pole elements 102a-102f. Such pole extension assembly may be employed to add additional pole elements to the extendable cleaning tool 100. In some embodiments, the opening 120 of the outermost pole element 102a may be configured to engage with and/or receive a pole extension adapter to enable further extension and increased length of the extendable cleaning tool 100, such as shown and described herein.

FIG. 1C illustrates a portion of the extendable cleaning tool 100 in unassembled form (the working head assembly 106 is omitted for clarity). FIG. 1C illustrates six pole elements 102a-102f that define or form an extendable pole device. A first pole element 102a defines an outermost pole element, with each of the remaining pole elements 102b-102f configured to fit within and be nested within the first pole element 102a (i.e. disposed substantially within). The first pole element 102a includes the first clamp 104a on an end thereof. The first clamp 104a is fixedly attached to the first pole element 102a and is configured to actuate and selectively attach to or engage with an outer surface of a second pole element 102a which fits within a hollow structure of the first pole element 102a.

Similarly, the second pole element 102b includes the second clamp 104b on an end thereof. The second clamp 104b is fixedly attached to the second pole element 102b and is configured to actuate and selectively attach to or engage with an outer surface of a third pole element 102c which fits within a hollow structure of the second pole element 102b. This arrangement continues for a fourth pole element 102d within the third pole element 102c, a fifth pole element 102e within the fourth pole element 102d, and a sixth pole element 102f within the fifth pole element 102e. The respective clamps 104c-104e provide for the selective engagement with the interior positioned pole elements 102d-104f. The sixth pole element 102f includes a respective sixth clamp 104f that is configured to engage with a neck or similar structure of the working head assembly 106. Although shown and described in FIGS. 1A-1C with the extendable cleaning tool 100 having six pole elements 102a-102f, those of skill in the art will appreciate that an extendable cleaning tool in accordance with the present disclosure can include any number of pole elements, and the present illustrated embodiment is merely provided for explanatory and illustrative purposes, and is not intended to be limiting.

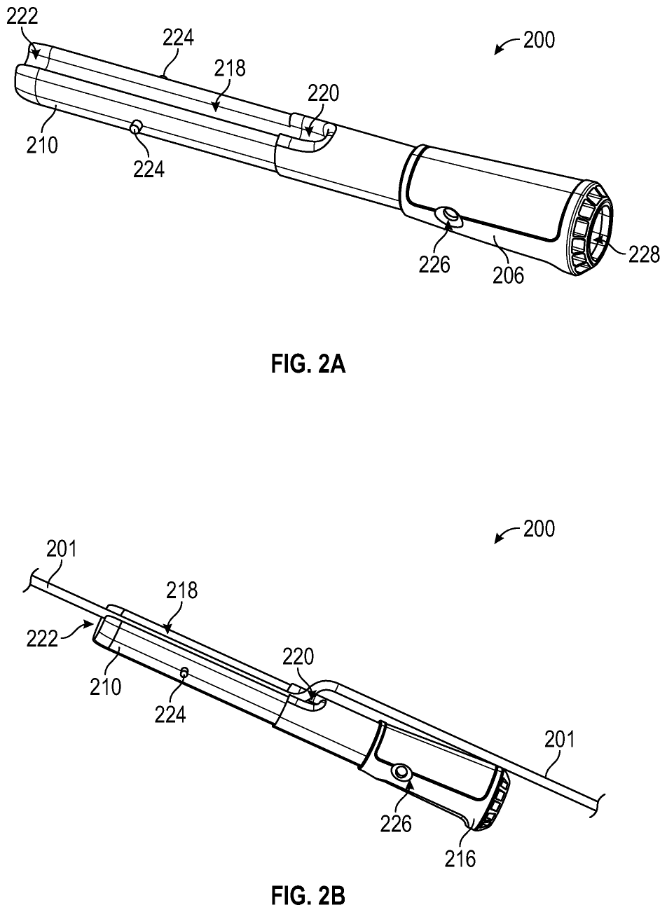

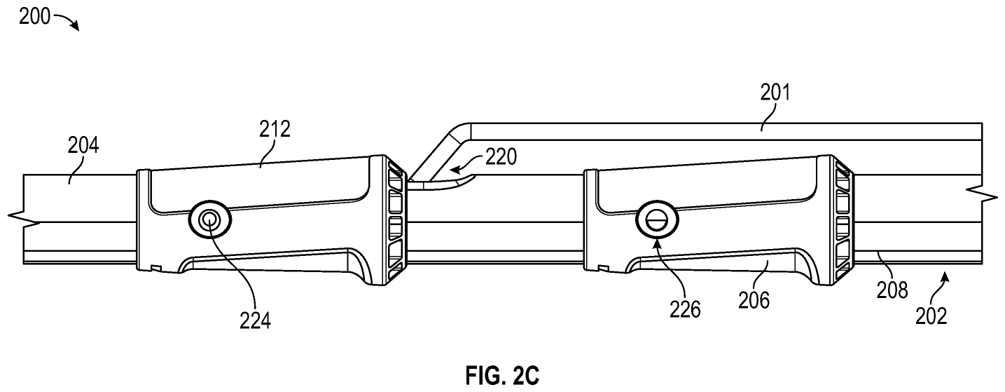

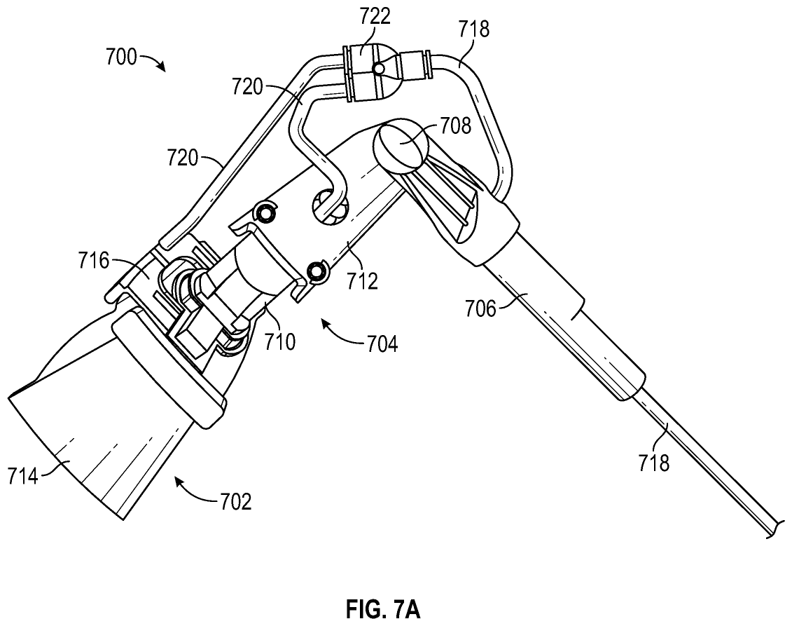

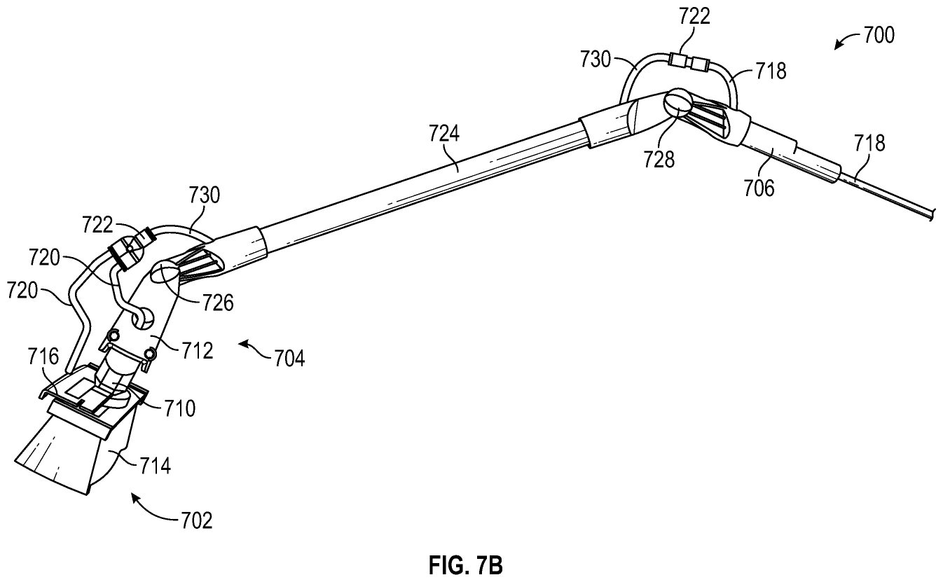

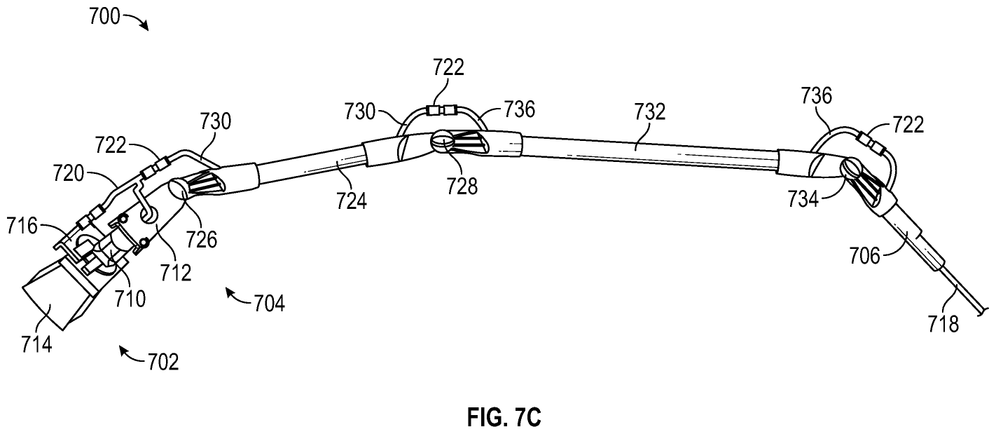

Turning now to FIGS. 2A-2C, schematic illustrations of a pole extension adapter 200 in accordance with an embodiment of the present disclosure are shown. FIG. 2A illustrates the pole extension adapter 200 in isolation, FIG. 2B illustrates the pole extension adapter 200 with a fluid conduit 201 arranged therein, and FIG. 2C illustrates the pole extension adapter 200 as connecting a pole extension structure 202 to a pole element 204. The pole element 204 may be similar to the first or outermost pole described with respect to FIGS. 1A-1C. The pole extension adapter 200 may be used with other embodiments disclosed herein, such as, for example, in FIGS. 7A-12, described below.

The pole extension adapter 200 is configured to connect two poles or the pole extension structure 202 to a pole element 204 of an extendable cleaning tool, such as shown and described with respect to FIGS. 1A-1C. The pole extension adapter 200 includes a first end 206 configured to engage with a first extension pole 208 of a pole extension structure 202 and a second end 210 configured to engage with a base 212 of the pole element 204. The first extension pole 208 is part of the pole extension structure 202. The pole extension structure 202 can include one or more extension poles which may be selectively connectable by one or more respective clamps, similar to the nested pole elements described in FIGS. 1A-1C and/or the clamps described below.

The second end 210 of the pole extension adapter 200 is configured to be inserted into the pole element 204 and defines a channel 218 having a channel inlet 220 and a channel outlet 222. The channel inlet 220 includes, as shown, a curved or smooth surface that directs the channel inlet 220 in a radially outward direction relative to an axis passing through the pole extension adapter 200. The channel inlet 220 may be arranged to be normal or radially facing relative to an axis passing through the pole extension adapter 200. The channel outlet 222 is open in a direction parallel with the axis of the pole extension adapter 200. As a result, when installed to the base 212 of the pole element 204, the pole extension adapter 200 defines an aperture through which a hose or other fluid conduit 201 may enter an interior hollow space of the pole element 204 (e.g., as shown in FIG. 2C). The pole extension adapter 200 can include one or more locking pins 224 that can pass through or into receiving apertures or recesses in the base 212 of the pole element 204 and thus lock or secure the pole extension adapter 200 to the base 212.

At the first end 206, the pole extension adapter 200 can include one or more pin apertures 226. The pin apertures 226 may be configured to receive a detent pin or other type of locking pin of the first extension pole 208. In this illustrative embodiment, the first extension pole 208 slides into and within the first end 206 of the pole extension adapter 200, which may be received through an opening 228 of the first end 206, as shown in FIG. 2A.

In operation, the fluid conduit 201 can be arranged within the pole element 204 and be fluidly connected to a working head (not shown). The working head can be configured to receive fluid flow (e.g., water, cleaning fluid, etc.) through the fluid conduit 201 or similar structure (e.g., a hose). The fluid conduit 201 can pass from an interior hollow of the pole element 204 through the channel 218 of the pole extension adapter 200 to an exterior environment (e.g., at the channel inlet 220). Advantageously, this configuration provides for an opening or passage for a hose to enter the interior hollow of the pole element 204. Because the channel inlet 220 is formed and defined by the pole extension adapter 200 there is no need for a specialized hose that is either permanently installed within the hollow pole element or that connects to an external adapter or threaded connection on the exterior of the pole structures. The pole extension adapter 200 provides for a structure to pass a hose or similar structure from an exterior area to within an internal channel or passage of a pole element. As such, embodiments of the present disclosure enable a user to employ any desired hose structure and is not specifically limited to unique or specialized or pre-installed hoses.

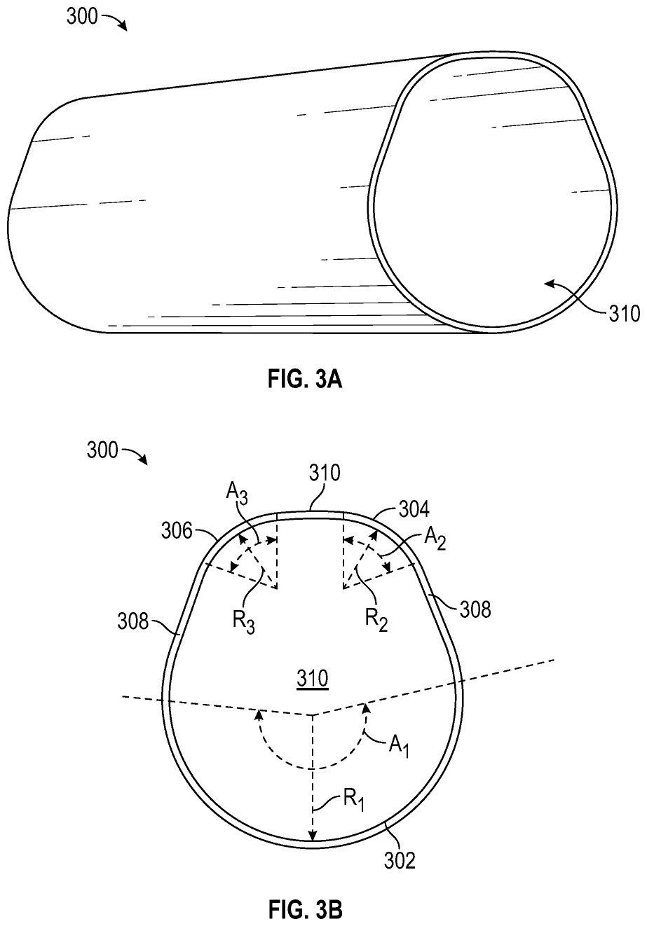

Turning now to FIGS. 3A-3B, schematic illustrations of a pole element 300 in accordance with an embodiment of the present disclosure are shown. FIG. 3A is an isometric illustration of the pole element 300 and FIG. 3B is an end-on view illustrating the shape of the pole element 300. The pole elements of the present disclosure may have non-circular geometries in cross-section. Such non-circular geometries can prevent relative rotation between two pole elements. For example, as shown in FIGS. 3A-3B, the pole element 300 that is illustratively shown, has a three lobe geometry.

As shown, the pole element 300 includes a first lobe 302, a second lobe 304, and a third lobe 306. Each of the lobes 302, 304, 306 is connected by intermediate sections 308 of the pole element 300. Each lobe 302, 304, 306 is defined by a continuous curved structure of the material of the pole element 300 having a substantially constant radius of curvature and such lobes 302, 304, 306 end when a curvature ends or a radius of curvature ends. As shown, the first lobe 302 is defined by a respective first radius of curvature R₁ which extends over a respective first angle A₁. Similarly, the second lobe 304 is defined by a respective second radius of curvature R₂ which extends over a respective second angle A₂ and the third lobe 306 is defined by a respective third radius of curvature R₃ which extends over a respective third angle A₃.

As shown, and noted above, the lobes 302, 304, 306 are connected by the intermediate sections 308, 310. In other configurations, one lobe can directly transition to another lobe based on a change in the radii of curvature between the two adjacent lobes. In the illustrative embodiment, the intermediate sections 308 are non-parallel, substantially straight sections that connect the different lobes 302, 304, 306. In other embodiments, the intermediate sections 308 may be parallel. In still further embodiments, the intermediate sections 308 extend tangentially from the lobes 302, 304, 306. In one such configuration of parallel substantially straight intermediate sections, a two-lobe configuration may be provided with a lobe at each side connected by two parallel substantially straight intermediate sections (e.g., a racetrack geometry). In another configuration having parallel straight intermediate sections, a four-lobe geometry may be provided, having two sets of parallel substantially straight sides, with each set normal to the other (e.g., a rounded corner square or rectangular geometry). The intermediate sections 308 may also be non-straight sections, which may have different curvatures than the lobes of the pole element (e.g., having a much larger radius of curvature). Such curved intermediate section 310 is illustrated between the second lobe 304 and the third lobe 306.

These non-circular geometries prevent relative rotation between pole elements, and thus clamps used to join together such pole elements are not required to provide engagement forces to prevent rotation (e.g., as necessary with circular geometry pole elements). As such, such clamps may only be required to secure translational or axial relative movement between pole elements. This allows for modified clamps that do not apply as much pressure or force upon the pole elements, which can reduce wear to the pole elements.

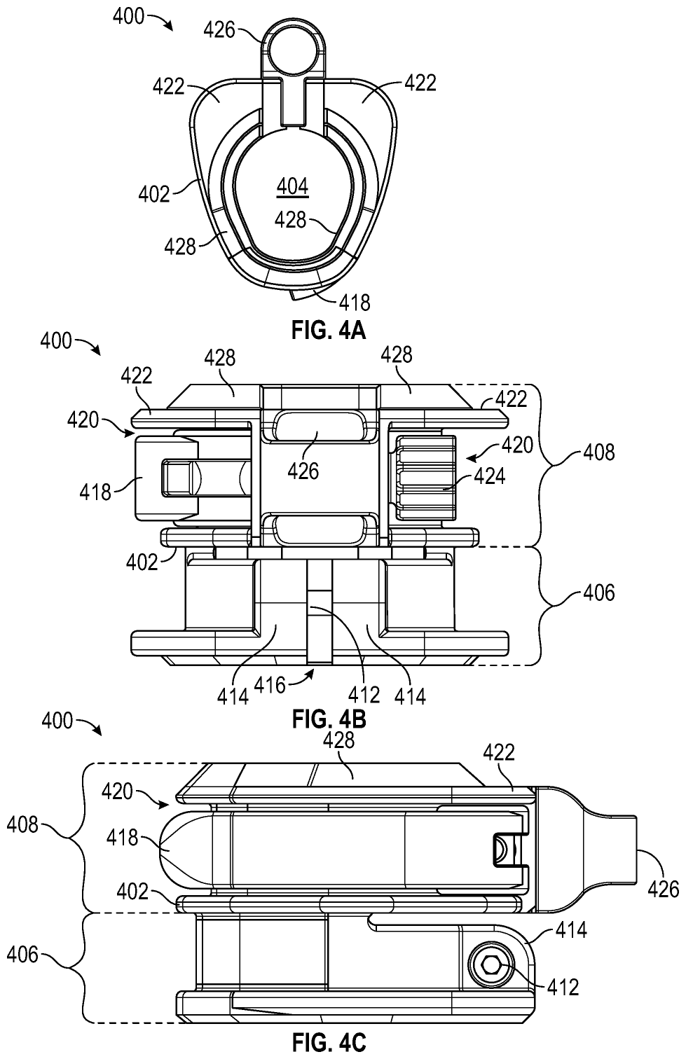

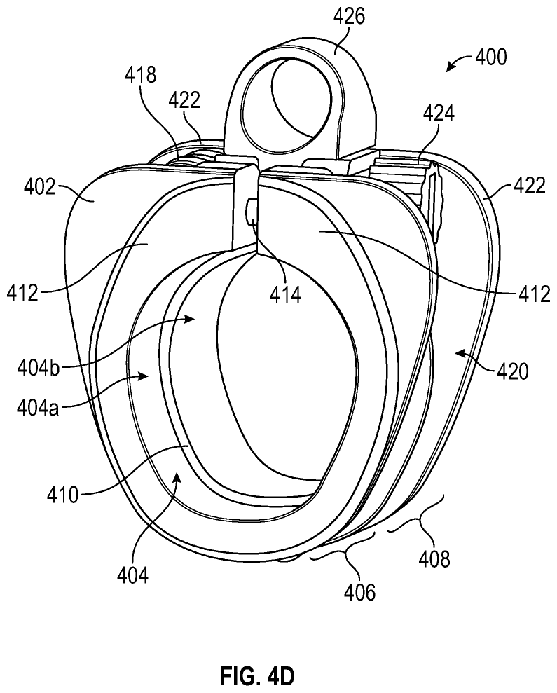

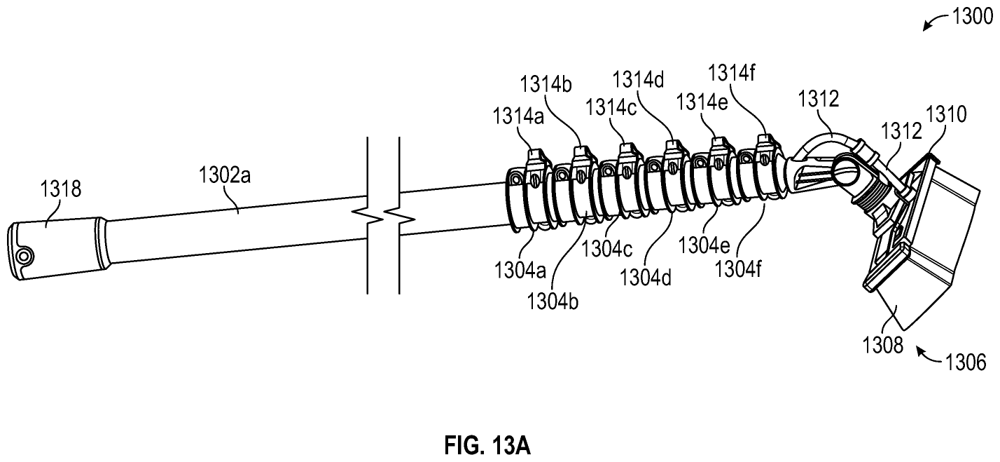

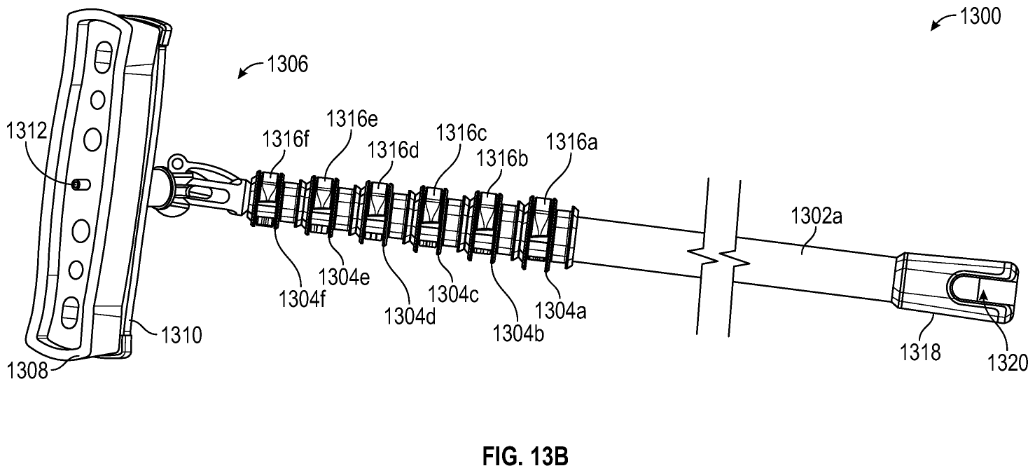

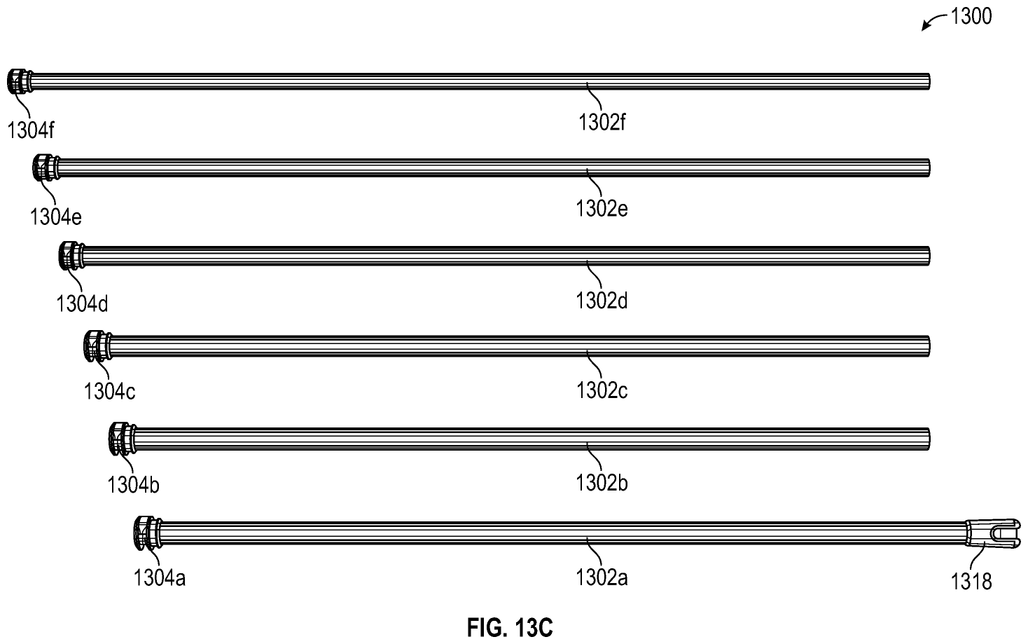

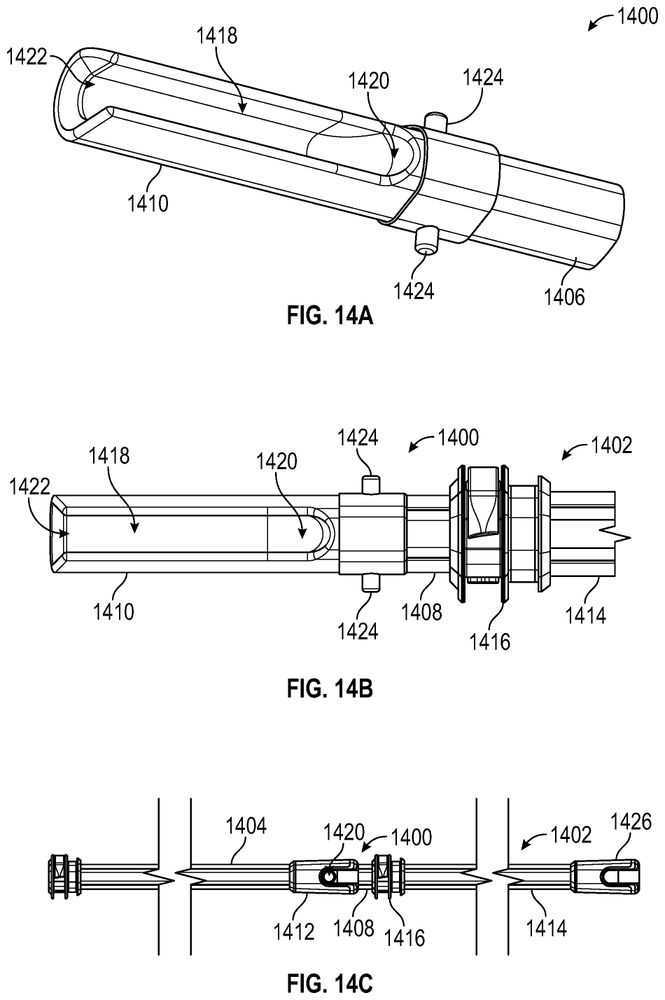

The pole element 300 includes a hollow interior 310. The hollow interior 310 allows for one or more pole elements to be arranged within the pole element 300 to form an extendable cleaning tool, such as shown and described herein. The hollow interior 310 may also allow for a hose or similar structure to pass therethrough, and thus enable a fluid conduit to be arranged within the hollow interior 310. In some configurations, the interior hollow 310 may be arranged to form a fluid conduit itself. It will be appreciated that the pole element 300 shown in FIGS. 3A-3B may be used with elements and features of other embodiments of the present disclosure, including, without limitation, the extendable cleaning tools of FIGS. 1A-1C and 13A-13C, the pole extension adapters FIGS. 2A-2C and 14A-14C, the clamps shown in FIGS. 4A-4D, 5, and 6, and the working head assembly of FIGS. 7A-7C.

Turning now to FIGS. 4A-4D, schematic illustrations of a clamp 400 in accordance with an embodiment of the present disclosure. FIG. 4A illustrates an elevation view of the clamp 400, FIG. 4B illustrates a top-down plan view of the clamp 400, FIG. 4C illustrates a side view of the clamp 400, and FIG. 4D illustrates an isometric illustration of the clamp 400. The clamp 400 includes a clamp body 402 defines an internal bore 404. The internal bore 404 is shaped and sized to receive one or more pole elements therethrough.

The clamp body 402 has a first portion 406 and a second portion 408. The first portion 406 of the clamp body 402 is configured to receive a first pole element and the second portion 408 of the clamp body 402 is configured to receive a second pole element. The first portion 406 is configured to selectively and fixedly engage with and secure to the first pole element, such as at an end of the first pole element. The second portion 408 is configured selectively and releasably engage with the second pole element. The first and second portion 406, 408 define similarly shaped bores but have a stepped nature such that a section 404a of the internal bore 404 within the first portion 406 is larger in dimension than a section 404b of the internal bore 404 within the second portion 408 (e.g., as shown in FIG. 4D). A stop surface 410 is defined at the step or location between the first portion 406 and the second portion 408. As such, the section 404a of the first portion 406 is configured to receive a pole element having a larger dimension than a pole element received within the section 404b of the second section 408 and the stop surface 410 is configured to define an extent to which the first pole section can pass into the clamp 400.

The first section 406 is configured to engage and clamp onto an end of a pole element that fits within the section 404a of the first portion 406 and contacts the stop surface 410. The connection or engagement between the first section 406 and the respective pole element may be selective and fixed. That is, once the first section 406 is clamped to a respective pole disengagement of the two elements is not simple. The engagement may be press-fit, friction, compression, etc. To apply pressure and engagement about a pole element, the first portion 406 of the clamp body 402 includes arms 412 through which a securing fastener 414 will apply a compression force to the first portion 406. The compression applied by the securing fastener 414 may be adjustable, in part, because the arms 412 of the first portion 406 are separated by a gap 416. The arms 412 may have flange-like structures for receiving the securing fastener 414 and providing for sufficient material to enable the compression and engagement to a pole element. The securing fastener 414 may be a bolt and nut configuration that provides for threaded connection and compression. In an embodiment, such connection can be substantially fixed.

In contrast, the second portion 408 of the clamp body 402 is configured to provide for selective and releasable engagement with a pole element. The selective and releasable engagement is provided by a lever 418, which may be a manual lever. The lever 418 is configured to allow for manual engagement and disengagement between the clamp 400 and a pole element that fits within the section 404b of the internal bore 404 within the second portion 408. Such pole element may also be configured to fit within and move relative to (e.g., translate) a first pole element that is secured within the section 404a of the internal bore 404 within the first portion 406. The lever 418 first within a lever channel 420 that is defined about an exterior of the second portion 408 of the clamp 400.

The lever 418 is configured to provide compression or tightening engagement between arms 422 of the second portion 408. The lever 418 is connected to an adjustment knob 424. The adjustment knob 424 is swappable or exchangeable with the lever 418 within the lever channel 420 such that the lever 418 may be provided with different arrangements on the clamp 400 (e.g., right-handed use or left-handed use). The lever 418 may be pivotable about a pivot pin in an off-set manner such that in the closed stated (e.g., shown in FIGS. 4A-4D) the lever 418 compresses with the adjustment knob 424 against the arms 422 to clamp onto an exterior surface of a pole element (e.g., engage with an outer or exterior surface of a pole element). The lever 418 is rotatable about the pivot pin, and because the lever has an off-set pivot, the compression force may be lessened, thus lessening the clamping force on the pole element (e.g., disengaging with an outer or exterior surface of a pole element). When in the open state, the pole element may be able to freely translate through the clamp 400, and thus enable extension or telescoping of one pole element relative to another pole element.

The clamp 400 includes a guide 426 that is secured by the lever 418 and adjustment knob 424 and between the arms 422 of the second portion 408 of the clamp body 402. The guide 426 is an optional feature that can be used to support and guide a hose or similar conduit along an exterior portion of an extendable cleaning tool. The guide 426 may also or alternatively be used to guide and/or support a pull string or pull cord and/or guide and/or support a power cable or similar electrical conduit along the extendable cleaning tool.

Further, as illustratively shown, the clamp 400 may include optional pole grips 428. The pole grips 428 may be pads or alternative materials of the clamp 400 that are arranged to engage with and contact surfaces of the pole elements. The pole grips 428 may be formed of a material that relatively softer or resilient than the rest of the material of the clamp 400. As such, when the lever 418 is moved from an open state to a closed state, the clamping force applied to the pole element may be less than if no such pole grips 428 were employed. In some embodiments, the pole grips 428 are integrally formed (i.e. co-molded) with the clamp body 402 within a single mold. The pole grips 428 can operation as a bumper to lessen impacts and hard surface contact with a pole element and may also provide for increased frictional contact (e.g., gripping strength) with a pole element and thus secure a pole element translationally relative to the clamp 400. The pole grips 428, in combination with the non-circular pole elements, can eliminate the need to account for relative rotation between pole elements, and thus be selected to provide anti-translational gripping only. Further, by incorporating the pole grips 428, the pole elements may be protected from wear when adjusted translationally relative to each other (e.g., during extension or collapsing of the extendable cleaning tool). In some embodiments, the pole grips 428 may be formed from thermoplastic rubber (“TPR”) or thermoplastic elastomer (“TPE”) or other soft rubber/rubber-like materials. As noted, the pole grips 428 may be co-molded with the clamp body 402.

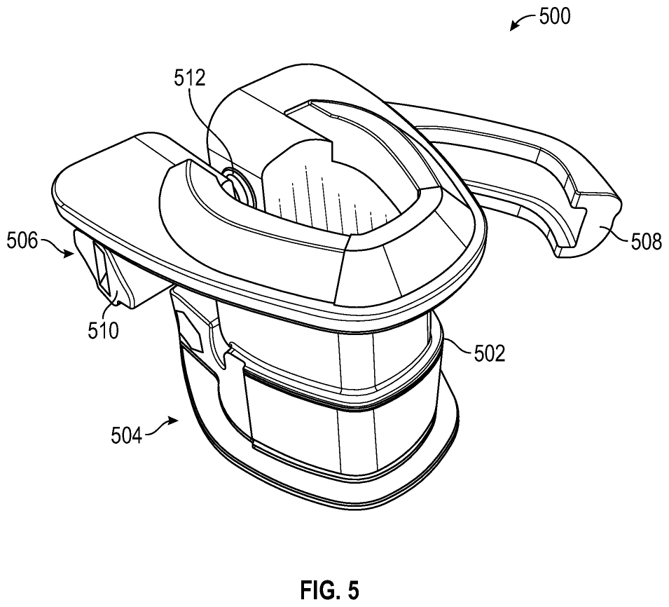

Turning now to FIG. 5, an illustration of a clamp 500 in accordance with an embodiment of the present disclosure is shown. The clamp 500 may be similar in structure and operation as that shown and described with respect to FIGS. 4A-4D, although the clamp 500 has a different overall design. The illustration of the clamp 500 shows a clamp body 502 having a first portion 504 and a second portion 506 which define an internal bore passing therethrough. The clamp 500 is configured to fixedly engage with a first pole element within the first portion 504 and releasably engage with a second pole element within the second portion 506.

The clamp 500 includes a lever 508 that connects to an adjustment knob 510. The lever 508 and adjustment knob 510 allow for switching of orientation of the lever 508. As such, for example, the clamp 500 may be customized for either right-handed use or left-handed use. In this embodiment, arranged between the lever 508 and the adjustment knob 510 (and between arms of the second portion 506 of the clamp body 502) is a biasing element 512. The biasing element 512 is configured to apply an outward force against the compression provided between the lever 508 and the adjustment knob 510. As such, when actuating the lever from a closed position to an open position, the biasing element 512 may provide an opening force to aid in this transition. The biasing element 512 may be a spring (e.g. a helical compression spring), a compressed material, or other structure that can be compressed and provide an outward, opening force. It will be appreciated that the biasing force provided by the biasing element 512 is not sufficient to open the lever 508 from a closed state or position alone, but rather the biasing element 512 is selected to aid a user in transitioning or actuating the lever 508 from the closed state to the open state. It should be appreciated that biasing element 512 allows the clamp 500 to open or disengage from the pole faster, or more completely, than a clamp without a biasing element. As a result, there is less wear on the pole as operators typically start sliding the pole while the clamp is at least partially engaged.

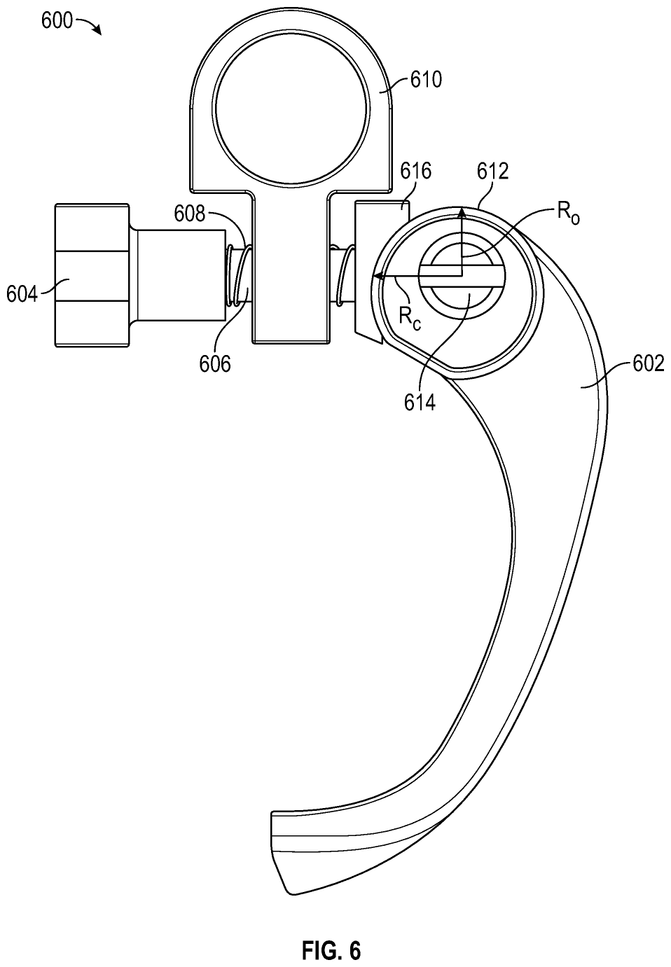

Turning now to FIG. 6, a portion of a clamp assembly 600 in accordance with an embodiment of the present disclosure is shown. The clamp assembly 600 may be arranged as part of a clamp as shown and described above. The portion of the clamp assembly 600 shown in FIG. 6 includes a lever 602, an adjustment knob 604, and a connection rod 606. Each of the lever 602 and the adjustment knob 604 may threadedly engage, snap-fit, or otherwise engage and attach to the connection rod 606. As shown, a biasing element 608 may be wrapped or arranged about the connection rod 606 and generate an outward biasing force to separate against both the lever 602 and the adjustment knob 604. The connection rod 606 also passes through an optional guide 610, similar to that shown and described above.

The lever 602 includes an offset axis end 612 that is rotatable about a pivot 614. The offset axis end 612 provides for a larger radius of engagement R_{c} when in the closed state and a smaller radius of engagement Rₒ when in the open state. As such, a separation distance between the offset axis end 612 of the lever 602 and the adjustment knob 604 may be greater in the open state than in the closed state. The portion of a clamp assembly 600 also includes an optional contact element 616 that is configured to increase a contact surface between the lever 602 and a portion of a clamp body. That is, because the offset axis end 612 is rounded, the contact element 616 is arranged to convert a force applied by the lever 602 from a rounded surface (which would result in a point or line contact with a part of the clamp body) into a flat surface of contact, and thus provide a more even distribution of force.

Turning now to FIGS. 7A-7C, schematic illustrations of a working head assembly 700 in accordance with an embodiment of the present disclosure are shown. FIG. 7A illustrates the working head assembly 700 in a first configuration, FIG. 7B illustrates the working head assembly 700 in a second configuration having an extension element, and FIG. 7C illustrates the working head assembly 700 in a third configuration having two extension elements. The working head assembly 700 may be installed at the end of a pole or extendable cleaning tool formed of multiple pole elements, similar to, for example, that shown and described above.

The working head assembly 700 includes a working head 702 that is movably mounted to a head connector 704. In the illustration of FIG. 7A, the head connector 704 is pivotably connected to a pole connector 706 about a pivot 708. The head connector 704 includes a first portion 710 that connects to the working head 702 and a second portion 712 that connects to the pole connector at the pivot 708. The head connector 704 can provide multiple degrees of movement or orientation of the working head 702 relative to the pole connector 706. The working head 702, in this illustrative embodiment, includes a brush 714 and a head mount 716. In alternative embodiments, the brush 714 may be replaced by other cleaning implements, such as squeegees, sponges, or mop heads, as will be appreciated by those of skill in the art.

In this illustrative configuration, the working head 702 is water-fed, meaning that water or other fluids (e.g., cleaning fluids) are supplied directly to the working head 702 and dispersed into or adjacent the material or structure of the cleaning implement, such as the brush 714 in this illustrative embodiment. The head mount 716 can provide for connection to one or more hoses or other fluid conduits. For example, as shown, a pole hose 718 is arranged to pass through the pole connector 706 and join to a head hose 720 by means of an optional hose connector 722. The head hose 720 may be a bifurcated or split hose. Each section of the head hose 720 can connect to the head mount 716 to provide a liquid directly into or adjacent the brush 714. As shown, one of the branches or sections of the head hose 720 may pass into and through the head connector 704 to supply a fluid within the bristles of the brush 714. In other embodiments, the head hose may be a single fluid path without any such bifurcation, and supply fluid to one or more specific locations. In some embodiments, the head hose 720 may be connected to a reservoir defined within the working head 702, which in turn can distribute or dispense a fluid (e.g., water and/or cleaning fluids) into and through the brush 714.

As shown in FIG. 7B, the head connector 704 is pivotably connected to a first extension element 724 about a first pivot 726. The first extension element 724 is pivotably connected to the pole connector 706 about a second pivot 728. A first extension hose 730 may be connected to the pole hose 718 proximate the second pivot 728 and the first extension hose 730 may be connected to the head hose 720 proximate the first pivot 726. The first extension hose 730 can connect to the pole hose 718 and the head hose 720 by respective hose connectors 722. The first extension hose 730 may pass within, through, or along the first extension element 724.

As shown in FIG. 7C, the head connector 704 is pivotably connected to the first extension element 724 about the first pivot 726. In this configuration, the first extension element 724 is pivotably connected a second extension element 732 about the second pivot 728. The second extension element 732 is pivotable connected to the pole connector 706 about a third pivot 734. A first extension hose 730 may be connected to the head hose 720 proximate the first pivot 726 and to a second extension hose 736 that passes along, within, or through the second extension element 732, proximate the second pivot 728. The first extension hose 730 can connect to the head hose 720 and the second extension hose 736 by respective hose connectors 722. The second extension hose 736 may be connected to the pole hose 718 proximate the third pivot 734. The second extension hose 736 can connect to the pole hose 718 by a respective hose connector 722. It will be appreciated that the hose connectors 722 may be optional or have different configurations, such as one-to-one hose connection, one-to-two hose connection, two-to-one hose connection, or the like.

The working head assembly 700 provides for a customizable and adjustable working head assembly that may be arranged at the end of a telescoping pole of an extendable cleaning tool. The pivots 726, 728, 734 of the working head assembly 700 can enable various different orientations and arrangements to enable a user to use the working head 702 to clean hard to reach locations and surfaces. Each of the pivots 726, 728, 734 may be optionally lockable such that the orientation of each of the relative components may be fixed in orientation, if desired. As described below, the pole connector 706 may be configured to be operable with different geometry poles, including circular and non-circular poles.

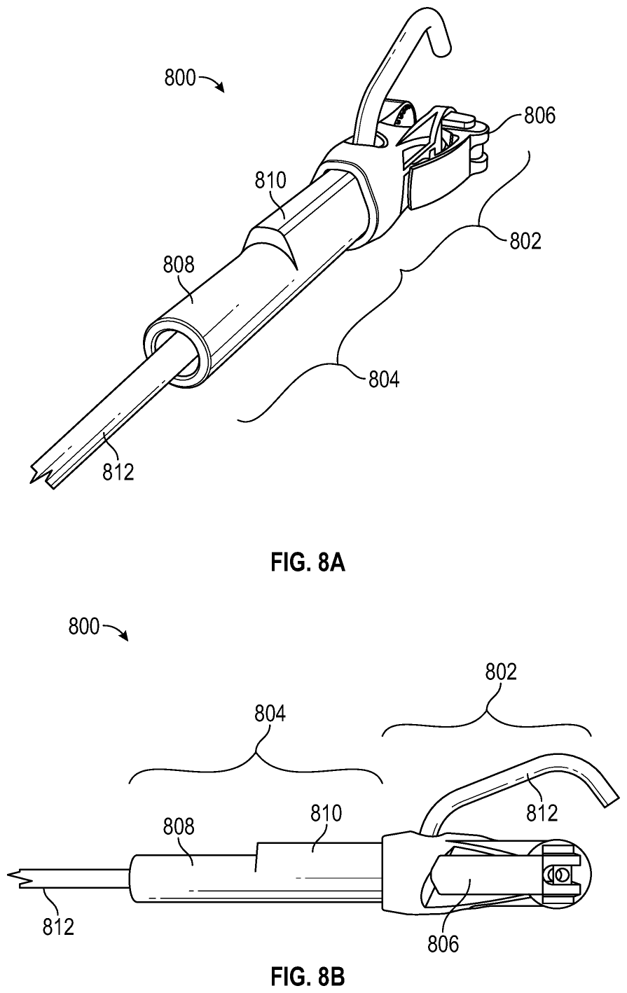

For example, turning now to FIGS. 8A-8B, schematic illustrations of a pole connector 800 in accordance with an embodiment of the present disclosure are shown. The pole connector 800 may be configured to connect a working head or a working head assembly to a pole, such as a telescoping pole described above. The pole connector 800 includes a pivot connection portion 802 and a pole connection portion 804. The pivot connection portion 802 is configured to pivotably connect to a working head or a working head assembly. The pivot connection portion 802 can include a locking handle 806 configured to provide releasable locking of a pivot connection between the pivot connection portion 802 and another structure or component.

The pole connection portion 804 is configured to engage with different geometry poles. For example, the pole connection portion 804 includes a circular connector 808 and a non-circular connector 810. The circular connector 808 is substantially rounded and circular in shape, excluding a channel for a hose 812 to pass through the pole connector 800. Because the circular connector 808 is circular in shape, the circular connector 808 may fit within and be connected to a pole having a circular geometry. The non-circular connector 810 has a geometry different than the circular connector 808 and is configured to engage with and connect to poles having mating geometries. In some embodiments, the non-circular connector 810 may be shaped connect with lobed-geometry poles, such as those shown and described herein. The non-circular connector 810 may have alternative geometries, such as squared or flat-sided geometries. The non-circular connector 810 is configured to connect to telescoping poles that are designed to be non-rotational between each pole element of the telescoping pole. It will be appreciated that, in some embodiments, the geometric shape of the pole connection portion 804 may be uniform for the length thereof. For example, in some embodiments, the entire pole connection portion can have a circular geometry (e.g., completely like the circular connector 808) or a non-circular geometry (e.g., completely like the non-circular connector 810). Further, although shown as a substantially 50-50 division of the circular connector 808 and the non-circular connector 810 shown in FIGS. 8A-8B, in other embodiments, the specific length of either connector portion may be different with one providing more than 50% of the total length of the pole connection portion 804, and the other being the remainder length.

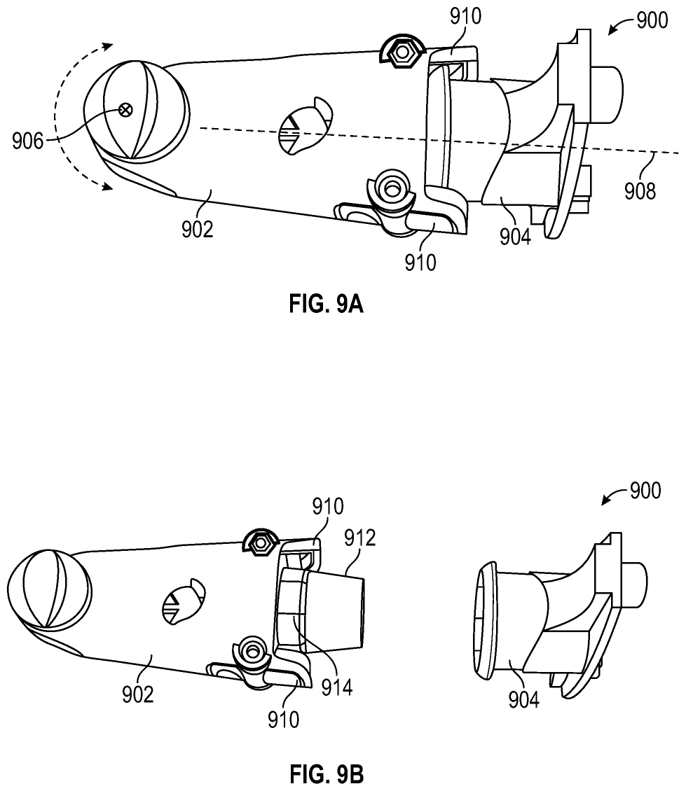

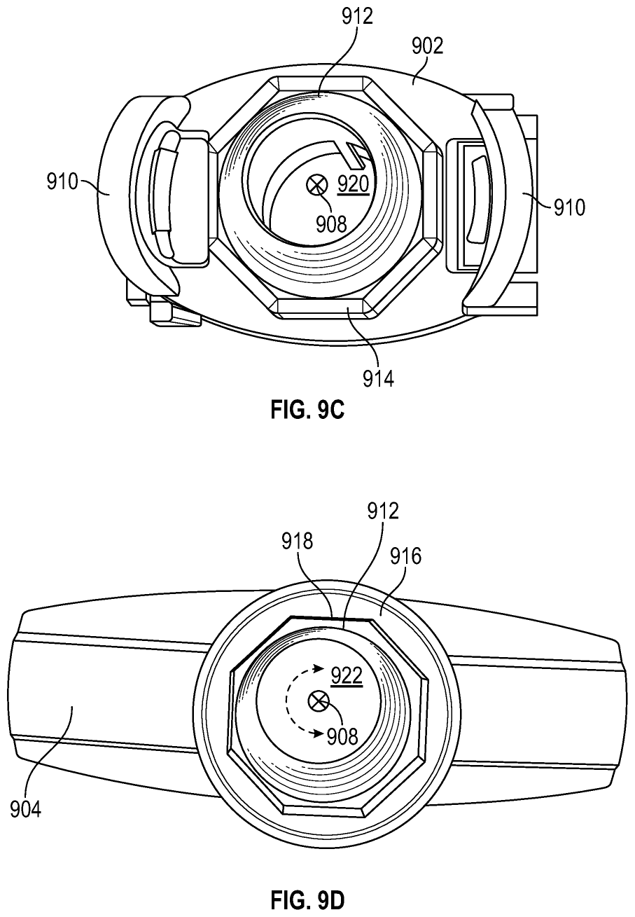

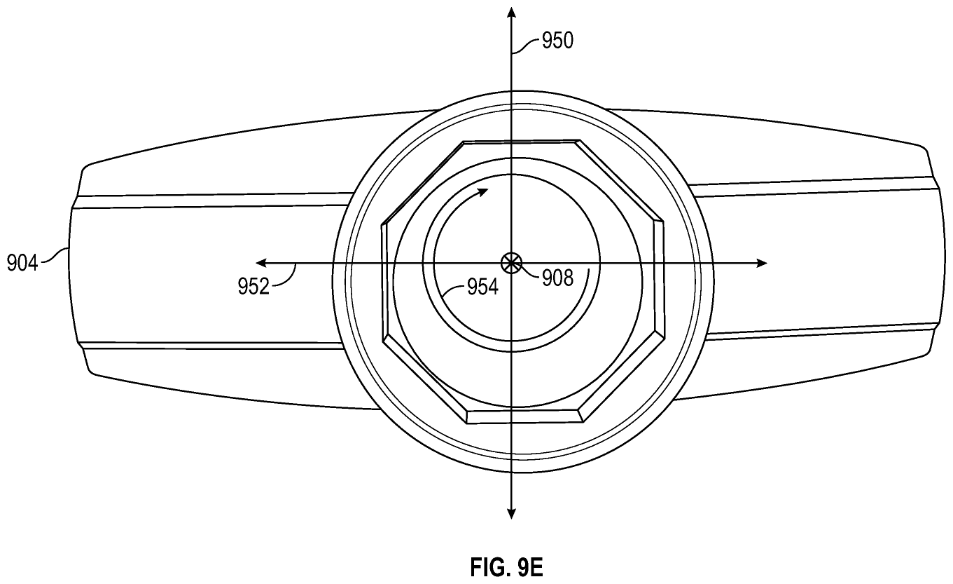

Turning now to FIGS. 9A-9E, schematic illustrations of a head connector 900 in accordance with an embodiment of the present disclosure are shown. FIG. 9A illustrates a side view of the head connector 900 as assembled and FIG. 9B illustrates a side view of the head connector 900 as separated into two components. The head connector 900 is configured to enable connection of a working head to a pole structure, either directly or through a working head/working head assembly. The head connector 900, in this illustrative embodiment, includes two parts, a pivot portion 902 and a connector portion 904. The pivot portion 902 is configured to pivot about a pivot axis 906, which may be defined by a connection with another structure (e.g., pole, extension element, etc.). The pivot portion 902 provides for a first degree of adjustment of the head connector 900, and thus adjustment of a brush or similar implement attached to the head connector 900.

The connector portion 904 is removably connected to the pivot portion 906 to provide a second degree of adjustment. The connector portion 904 is rotatable about a head connector axis 908. In this illustrative embodiment, the pivot portion 902 includes one or more securing elements 910 that can selectively connect the pivot portion 902 and the connector portion 904 together. In other embodiments, the securing elements 910 may be part of the connector portion and selectively engage with the pivot portion. The securing elements 910 are illustratively shown as snap connections that can be manually operated by a user. Various other connection and types of connectors are contemplated herein, and the fastener illustrated is merely for illustrative and explanatory purposes and is not intended to be limiting. The connector portion 904 is configured to connect to or support a cleaning device, such as a brush, squeegee, sponge, etc., as will be appreciated by those of skill in the art.

FIG. 9C illustrates a view of the pivot portion 902 along the head connector axis 908 and FIG. 9D illustrates a view of the connector portion 904 along the head connector axis 908. As shown in FIG. 9C, the pivot portion 902 includes a first connector 912 which has a polygonal base 914. As shown in FIG. 9D, the connector portion 904 includes a second connector 916 which has an interior polygonal bore 918. The first connector 912 is configured to be inserted into the second connector 916. Because of the polygonal geometries 914, 918 of the first and second connectors 912, 916, the connector portion 904 may be installed at different orientations about the head connector axis 908. In this illustrative embodiment, the polygonal geometries 914, 918 are in the form of an octagon, which enables rotation of the connector portion 904 relative to the pivot portion 902 in 45° increments. It will be appreciated that other polygonal geometries may be employed that can allow for greater or smaller degree increments of relative rotation. It will be noted that the orientation of the connector portion 904 relative to the pivot portion 902 is adjustable by separation of the connector portion 904 from the pivot portion 902. When separated, the connector portion 904 can be rotated relative to the pivot portion 902, and then the second connector 916 may be slid over the first connector 912, and the securing elements 910 can secure the connector portion 904 to the pivot portion 902 in the desired orientation.

In some embodiments, and as shown in FIGS. 9C-9D, each of the connector portion 904 and the pivot portion 902 can include internal through-holes 920, 922. The internal through-holes 920, 922 can allow for fluid to pass through the head connector 900 to a cleaning implement that is connected to the connector portion 904. In some embodiments, a hose or other structure may be arranged within the internal through-holes 920, 922 with such device connecting to a brush, a reservoir, or to otherwise deliver and/or dispense fluid at a working head of a cleaning device/implement.

As discussed above, the head connector shown and described in FIGS. 9A-9D provides for adjustment about two axis, one about the pivot axis 906 of the pivot portion 902 and one about the head connector axis 908 by adjusting the connection orientation of the connector portion 904 to the pivot portion 902. In some embodiments, additional degrees of adjustment may be provided.

For example, as shown in FIG. 9E, the connector portion 904 may be configured to enable at least three degrees of movement or adjustment (e.g., three or more). Such a configuration may be achieved by having the connection portion 904 arranged as a universal joint, a combination of discrete joints and/or pivots, or the like. In this illustration of FIG. 9E, the connector portion 904 (alone or in combination with the pivot portion 902), can provide relative movement or adjustment in a forward-backward direction 950, a side-to-side direction 952, and/or a rotational direction 952. Thus, the movement about the head connector axis 908 can be more than mere rotation or a single pivot, but rather can be implemented to enable greater freedom of movement or adjustment to enable an orientation of a cleaning head as desired by a user.

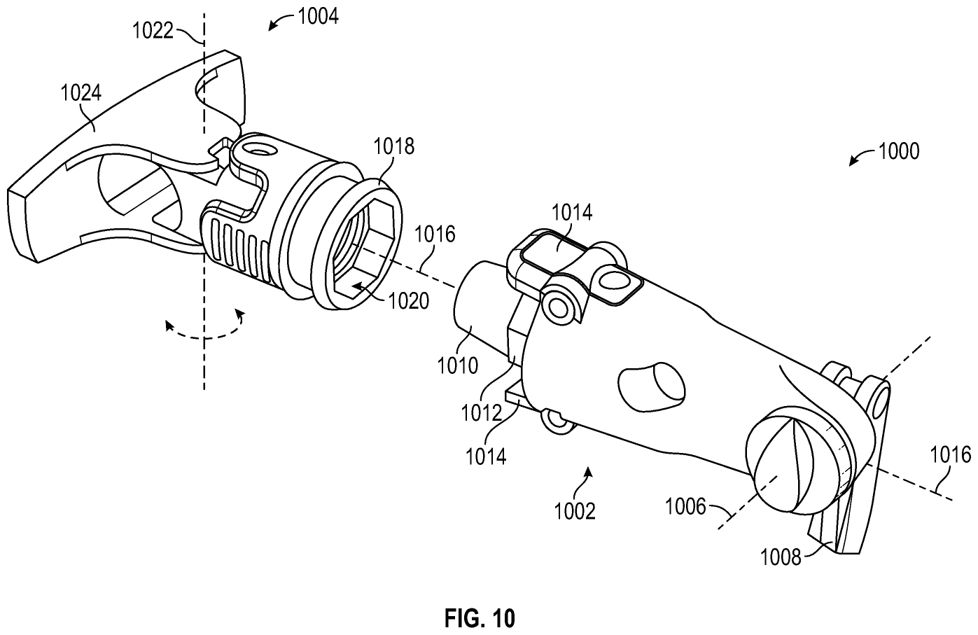

Turning now to FIG. 10, an unassembled schematic illustration of a head connector 1000 in accordance with an embodiment of the present disclosure is shown. The head connector 1000 is configured to enable connection of a working head to a pole structure, either directly or through a working head/working head assembly. The head connector 1000, in this illustrative embodiment, includes two parts, a pivot portion 1002 and a connector portion 1004.

The pivot portion 1002 is configured to pivot about a pivot axis 1006, which may be defined by a connection with another structure (e.g., pole, extension element, etc.), as described above. The pivot portion 1002 provides for a first degree of adjustment of the head connector 1000 about the pivot axis 1006, and thus adjustment of a brush or similar implement attached to the head connector 1000. The pivot portion 1002, as shown, includes a locking lever 1008 to secure the head connector 1000 about the pivot axis 1006 and thus lock/fix a first degree of adjustment. The pivot portion 1002 also includes a first connector 1010 having a polygonal base 1012 that operates in combination with one or more securing elements 1014 to secure a second degree of adjustment about a head connector axis 1016.

The connector portion 1004 is configured to connect to or support a cleaning device, such as a brush, squeegee, sponge, etc., as will be appreciated by those of skill in the art, such as any of the working heads described herein. In this embodiment, the connector portion 1004 provides an additional degree of adjustment of the supported cleaning device. As shown, the connector portion 1004 includes a second connector 1018 which has an interior polygonal bore 1020 configured to mate or engage with the first connector 1010 of the pivot portion 1002. The second connector 1018 is configured to pivot about a connector rotational axis 1022. As such, a connecting end 1024 of the connector portion 1004 may be adjusted about the connector rotational axis 1022 and thus provide a third degree of adjustment.

Turning now to FIG. 11, a schematic illustration of a portion of a working head assembly 1100 in accordance with an embodiment of the present disclosure is shown. The working head assembly 1100 includes a working head 1102 having a brush 1104 and a head mount 1106. The head mount 1106 is attached to a head connector 1108, with only the connector portion 1110 shown. The connector portion may be attachable to a pivot portion to form a complete head connector, as shown and described herein.

FIG. 11 illustrates the rotation about a connector rotational axis 1112 of the head connector 1108. As shown, the connector portion 1110 is shown in a first position in FIG. 11 in solid line, and in a second position shown as connector portion 1110a in dashed line. In some embodiments, and as shown in FIG. 11, the connector portion 1108 includes an optional lock or locking element, for example as described below, for securing the angled position or orientation of the connector portion 1110 relative to the head connector 1108 about the connector rotational axis 1112. The working head assembly 1100 may be used with systems and structures as described herein, including, without limitation, the extendable cleaning tools of FIGS. 1A-1C and 13A-13C, the pole extension adapters FIGS. 2A-2C and 14A-14C, the clamps shown in FIGS. 4A-4D, 5, and 6, and the working head assembly of FIGS. 7A-7C.

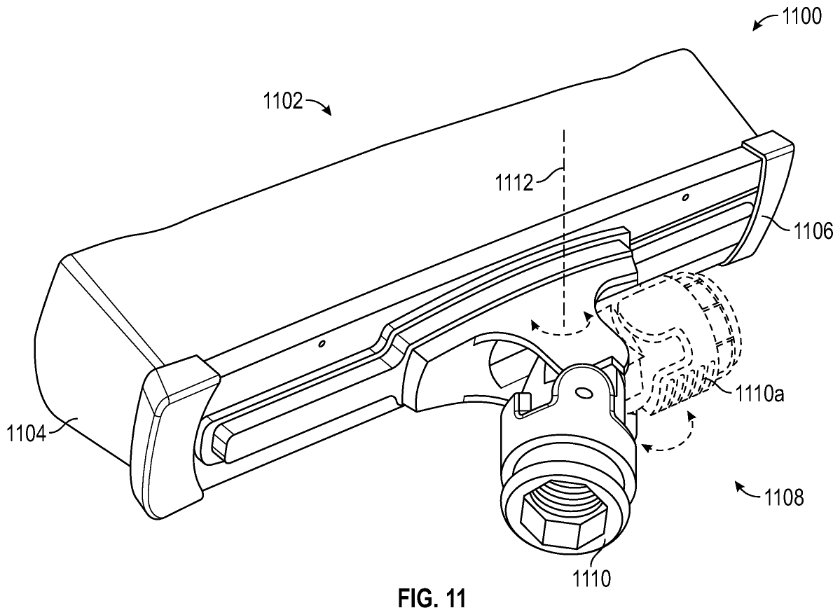

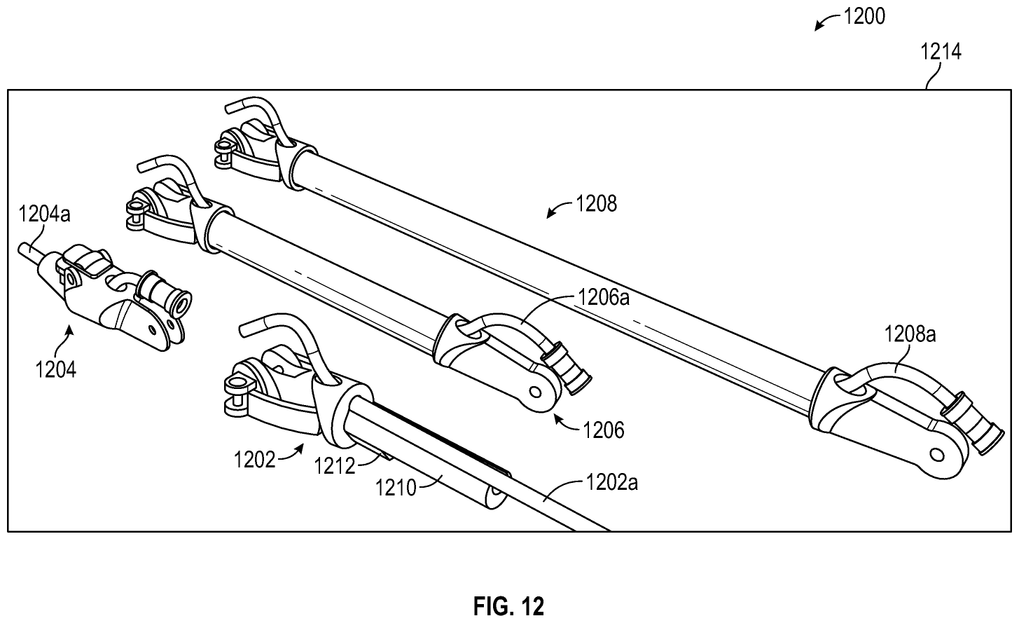

Turning now to FIG. 12, a kit 1200 for an extendable cleaning tool in accordance with an embodiment of the present disclosure is shown. The kit 1200 is configured to enable assembly of a neck or extension structure for an extendable cleaning tool. The kit includes a pole connector 1202, a head connector 1204, a first extension element 1206, and a second extension element 1208. The pole connector 1202, the head connector 1204, the first extension element 1206, and the second extension element 1208 may be pivotably connectable and assembled in different configurations to provide a customizable neck or extension structure for an extendable cleaning tool. In some such kits, and as shown, the pole connector 1202, the head connector 1204, the first extension element 1206, and the second extension element 1208 may each include respective internal hose structures 1202a, 1204a, 1206a, 1208a. The internal hose structures 1202a, 1204a, 1206a, 1208a can be connected, when assembled, to form a fluid path or conduit through the assembled structure. The pole connector 1202 can be configured for engagement with poles or extension poles of different geometries. That is, the pole connector 1202 can include a circular connector 1210 and a non-circular connector 1212, for example, as shown and described above. As such, the kit 1200 can be used with different geometry poles. In further embodiments, the kit may also include one or more working heads and/or one or more poles and/or pole extensions, for example, as show and described above. The individual components of the kit 1200 may be contained in packaging 1214. The packaging 1214 for the kit 1200 may be made of one or more of, for example, plastics, cardboard, polymers, metals, and or fiber materials.

Referring now to FIGS. 13A-13C, schematic illustrations of an extendable cleaning tool 1300 in accordance with an embodiment of the present disclosure are shown. FIG. 13A is a side schematic illustration of the extendable cleaning tool 1300, FIG. 13B is a bottom schematic illustration of the extendable cleaning tool 1300, and FIG. 13C is an unassembled illustration showing portions of the extendable cleaning tool 1300. The extendable cleaning tool 1300 is a telescoping pole configuration that incorporates nested pole elements that are selectively engageable with each other to allow for customizable pole lengths.

As shown in FIGS. 13A-13C, the extendable cleaning tool 1300 includes pole elements 1302a-1302f which are nested within each other to form an extendable and telescoping pole configuration. Each pole element 1302a-1302f includes a respective clamp 1304a-1304f on an end thereof. The clamps 1304a-1304f are configured to provided selective fixed engagement between an outer pole element to an inner pole element of the pole elements 1302a-1302f, which allows for the telescoping nature of the extendable cleaning tool 1300. At one end of the extendable cleaning tool 1300, and attached to an innermost pole element 1302f, is a working head assembly 1306. As used herein, the “innermost” pole is disposed substantially radially inward from, or disposed within, the next adjacent pole when the extendable cleaning tool is in a collapsed state. The working head assembly 1306 may selectively engage and be attached to the innermost pole element 1302f by an associated clamp 1304f of the innermost pole element 1302f.

The working head assembly 1306, as shown, has a brush configuration, including a brush 1308, a head mount 1310, and one or more fluid conduits 1312. The brush 1308 may incorporate one or more types or sets of bristles configured to enable scrubbing of a surface, such as a glass surface or wall. The pole elements 1302a-1302f are hollow. The hollow interior enables the nesting of the pole elements 1302a-1302f and also enables, in some embodiments, a hose or other fluid conduit structure to be passed therethrough and fluidly connect to the fluid conduit 1312 of the working head assembly 1306. As such, the fluid conduit 1312 can be used for a water-fed working head assembly 1306, which provides liquids (e.g. water or a cleaning solution) directly into or at the brush 1308 or other cleaning implement. In some embodiments, the hollow interior of the pole elements 1302a-1302f may define a fluid conduit that does not require a separate hose passed therethrough. Further, in some embodiments, a hose or other conduit structure may be supported along an exterior of the extendable cleaning tool 1300 by optional guides 1314a-1314f, which are part of or connected to the respective clamps 1304a-1304f.

As shown in FIG. 1B, each clamp 1304a-1304f includes a manual actuator element 1316a-1316f. The manual actuator elements 1316a-1316f enable a user to loosen an engagement between one pole element 1302a-1302f and another pole element 1302a-1302f, to allow two of the pole elements 1302a-1302f to translate, slide, or other move in an axial direction relative to each other in order to increase or decrease a total length of the extendable cleaning tool 1300. The clamps 1304a-1304f are configured to provide pressure or friction engagement between one pole element 1302a-1302f and another pole element 1302a-1302f The clamps 1304a-1304f, in isolation, may define internal apertures through which an associated pole element 1302a-1302f may be installed and attached. The clamps 1304a-1304f may further includes at least one element that is actuated by the manual actuator elements 1316a-1316f that passes through a respective pole element 1302a-1302f to engage with another pole element 1302a-1302f that is interior to the respective pole element 1302a-1302f.

An outermost pole element 1302a includes a base 1318. The base 1318 of the outermost pole element 1302a may be arranged as a handle for manual gripping and holding of the extendable cleaning tool 1300. The base 1318 may also include, as shown in FIG. 13B, a recess 1320. The recess 1320 may be configured to receive a hose, tube, or other fluid conduit structure, and guide such hose, tube, or other fluid conduit structure into an interior hollow of the pole element 1302a-1302f of the extendable cleaning tool 1300. The base 1318 may also be configured to receive a pole extension assembly in order to enable extension of the extendable cleaning tool 1300 beyond the length provided by the extendable pole elements 1302a-1302f.

FIG. 13C illustrates a portion of the extendable cleaning tool 1300 in unassembled form (the working head assembly 1306 is omitted for clarity). FIG. 13C illustrates six pole elements 1302a-1302f that define or form an extendable pole device. A first pole element 1302a defines an outermost pole element, with each of the remaining pole elements 1302b-1302f configured to fit within and be nested within the first pole element 1302a (i.e. disposed substantially within). The first pole element 1302a includes the first clamp 1304a on an end thereof. The first clamp 1304a is fixedly attached to the first pole element 1302a and is configured to actuate and selectively attach to or engage with an outer surface of a second pole element 1302a which fits within a hollow structure of the first pole element 1302a.

Similarly, the second pole element 1302b includes the second clamp 1304b on an end thereof. The second clamp 1304b is fixedly attached to the second pole element 1302b and is configured to actuate and selectively attach to or engage with an outer surface of a third pole element 1302c which fits within a hollow structure of the second pole element 1302b. This arrangement continues for a fourth pole element 1302d within the third pole element 1302c, a fifth pole element 1302e within the fourth pole element 1302d, and a sixth pole element 1302f within the fifth pole element 1302e. The respective clamps 1304c-1304e provide for the selective engagement with the interior positioned pole elements 1302d-1304f The sixth pole element 1302f includes a respective sixth clamp 1304f that is configured to engage with a neck or similar structure of the working head assembly 1306. Although shown and described in FIGS. 13A-13C with the extendable cleaning tool 1300 having six pole elements 1302a-1302f, those of skill in the art will appreciate that an extendable cleaning tool in accordance with the present disclosure can include any number of pole elements, and the present illustrated embodiment is merely provided for explanatory and illustrative purposes, and is not intended to be limiting.

Turning now to FIGS. 14A-14C, schematic illustrations of a pole extension adapter 1400 in accordance with an embodiment of the present disclosure. FIG. 14A illustrates the pole extension adapter 1400 in isolation, FIG. 14B illustrates the pole extension adapter 1400 installed at the end of a pole extension structure 1402, and FIG. 14C illustrates the pole extension adapter 1400 as connecting the pole extension structure 1402 to a pole element 1404. The pole element 1404 may be similar to the first or outermost pole described with respect to FIGS. 1A-1C or FIGS. 13A-13C, for example. It will be appreciated that the pole extension adapter 1400 may be employed with any of the above described embodiments

The pole extension adapter 1400 is configured to connect two poles or the pole extension structure 1402 to a pole element 1404 of an extendable cleaning tool, such as shown and described with respect to FIGS. 1A-1C or FIGS. 13A-13C, for example. The pole extension adapter 1400 includes a first end 1406 configured to engage with a first extension pole 1408 and a second end 1410 configured to engage with a base 1412 of the pole element 1404. The first extension pole 1408 is part of the pole extension structure 1402. The pole extension structure 1402, in this embodiment, includes two extension poles 1408, 1414 which are selectively connectable by a clamp 1416, similar to the nested pole elements described in FIGS. 1A-1C or FIGS. 13A-13C, for example.

The second end 1410 of the pole extension adapter 1400 defines a channel 1418 having a channel inlet 1420 and a channel outlet 1422. The channel inlet 1420 includes, as shown, a curved or smooth surface that directs the channel inlet 1420 in a radially outward direction relative to an axis passing through the pole extension adapter 1400. The channel outlet 1422 is open in a direction parallel with the axis of the pole extension adapter 1400. As a result, when installed to the base 1412 of the pole element 1404, the pole extension adapter 1400 defines an aperture through which a hose or other fluid conduit may enter an interior hollow space of the pole element 1404 (e.g., as shown in FIG. 14C). The pole extension adapter 1400 can include one or more locking pins 1424 that can pass through or into receiving apertures or recesses in the base 1412 of the pole element 1404 and thus lock or secure the pole extension adapter 1400 to the base 1412. As shown, one of the extension poles 1414 includes a base 1426 that may be similar to the base 1412 of the pole element 1404 and allow for engagement with another pole extension adapter and thus further increase a length of a formed extendable cleaning tool. It should be appreciated that the extension pole adapter allows for coupling of multiple poles together to allow the operator a wider operating range for cleaning operations.

In operation, a hose can be arranged within the pole element 1404 and be fluidly connected to a working head (not shown). The working head can be configured to receive fluid flow (e.g., water, cleaning fluid, etc.) through the hose or similar structure. The hose can pass from an interior hollow of the pole element 1404 through the channel 1418 to an exterior environment (e.g., at the channel inlet 1420). Advantageously, this configuration provides for an opening or passage for a hose to enter the interior hollow of the pole element 1404. Because the channel inlet 1420 is formed between the base 1412 and the pole extension adapter 1400 there is no need for a specialized hose that is either permanently installed within the hollow pole element or that connects to an external adapter or threaded connection on the exterior of the pole structures. The pole extension adapter 1400 provides for a structure to pass a hose or similar structure from an exterior area to within an internal channel or passage of a pole element. As such, embodiments of the present disclosure enable a user to employ any desired hose structure and is not specifically limited to unique or specialized or pre-installed hoses.

It will be appreciated that the pole extension adapter of FIGS. 2A-2C and 14A-14C are example adapters, and other adapters may be employed with extendable cleaning tools of the present disclosure. Further, it will be appreciated that different illustrative embodiments include features that can be interchanged and employed within other embodiments. For example, the working head assembly shown in FIGS. 7A-7C may be employed with different pole configurations, shown and described herein. Furthermore, although generally shown and described as telescoping pole configurations, modular pole configurations with individual pole elements that can be connected to form an extended cleaning pole can be employed with various elements and embodiments shown and described herein.

Turning now to FIG. 15, a schematic illustration of a portion of a working head assembly 1500 in accordance with an embodiment of the present disclosure is shown. The working head assembly 1500 includes a working head 1502 having a brush 1504 and a head mount 1506. The head mount 1506 is attached to a head connector 1508, with only the connector portion 1510 shown. The connector portion may be attachable to a pivot portion to form a complete head connector, as shown and described herein.

FIG. 15 illustrates the rotation about a connector rotational axis 1512 of the head connector 1508. As shown, the connector portion 1510 is shown in a first position in FIG. 15 in solid line, and in a second position shown as connector portion 1510a in dashed line or opaque outline. In some embodiments, and as shown in FIG. 15, the connector portion 1508 includes an optional locking element 1514 for securing the angled position or orientation of the connector portion 1510 relative to the head connector 1508 about the connector rotational axis 1512. The working head assembly 1500 may be used with systems and structures as described herein, including, without limitation, the extendable cleaning tools of FIGS. 1A-1C and 13A-13C, the pole extension adapters FIGS. 2A-2C and 14A-14C, the clamps shown in FIGS. 4A-4D, 5, and 6, and the working head assembly of FIGS. 7A-7C.

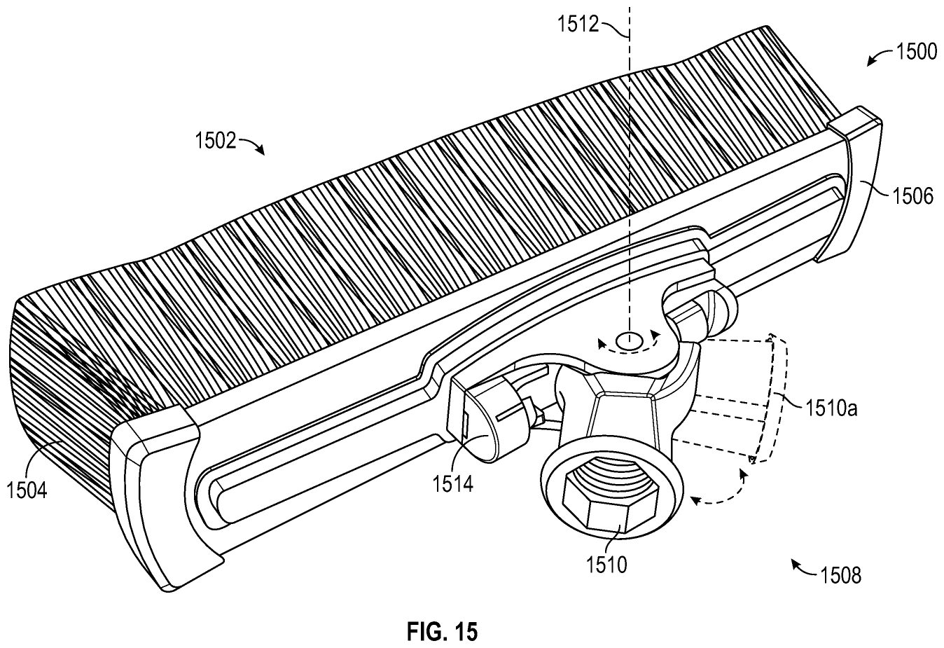

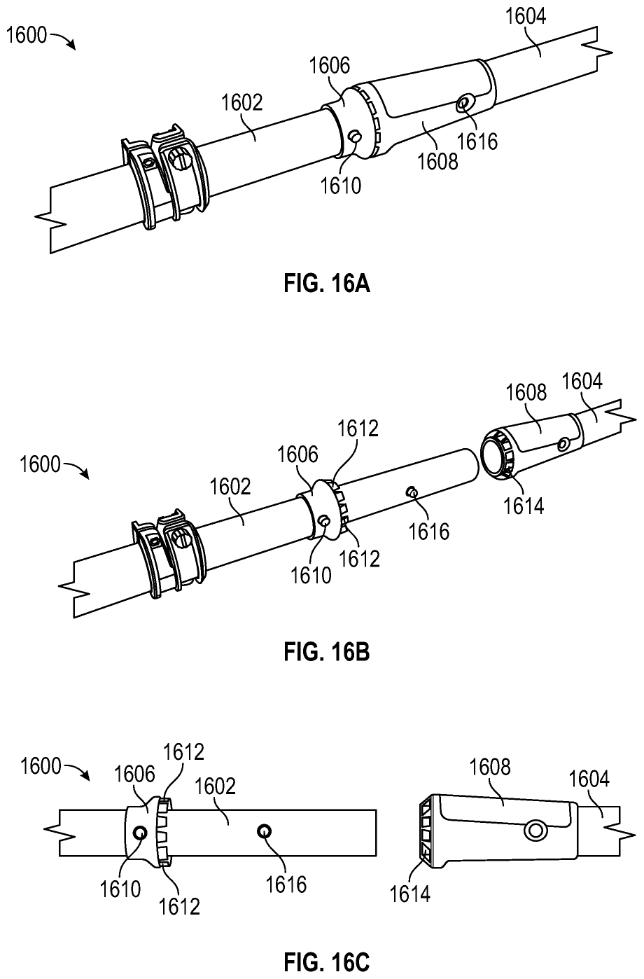

Turning now to FIGS. 16A-16C, schematic illustrations of a connection assembly 1600 for use with extendable cleaning tools in accordance with an embodiment of the present disclosure are shown. As shown, the connection assembly 1600 is configured to join a first pole element 1602 with a second pole element 1604. In this illustrative configuration, the first pole element 1602 includes an anti-rotation member 1606 that is configured to securely engage with a base 1608 of the second pole element 1604. The anti-rotation member 1606 may be attached to the first pole element 1602 by a first detent pin 1610, as shown. In other embodiments, the anti-rotation member 1606 may be attached to the first pole element 1602 by other means, including, but not limited to, adhesives, bonding, welding, fastener attachment, integral formation, or the like. As shown, the anti-rotation member 1606 includes a plurality of protrusions 1612. The protrusions 1612 of the anti-rotation member 1606 are configured to engage with recesses 1614 of the base 1608 of the second pole element 1604.

When the base 1608 of the second pole element 1604 is slid over an end of the first pole element 1602, the base 1608 will engage with the anti-rotation member 1606, as shown in FIG. 16A. The base 1608 of the second pole element 1604 may also engage with and be secured to the first pole element 1602 by one or more detent pins 1616, similar to that described above. The interaction of the protrusions 1612 of the anti-rotation member 1606 with the recesses 1614 of the base 1608 may prevent relative rotation between the first pole element 1602 and the second pole element 1604. Although shown in FIGS. 16A-16C in a particular configuration with a single base and a single anti-rotation member, those of skill in the art will appreciate that an extendable cleaning tool in accordance with embodiments of the present disclosure may include multiple anti-rotation members that are joinable with different bases along the length of the tool. The anti-rotation members, in combination with the engaged bases, provides additional anti-rotation functionality such that relative rotation of joined pole elements is minimized or prevented.

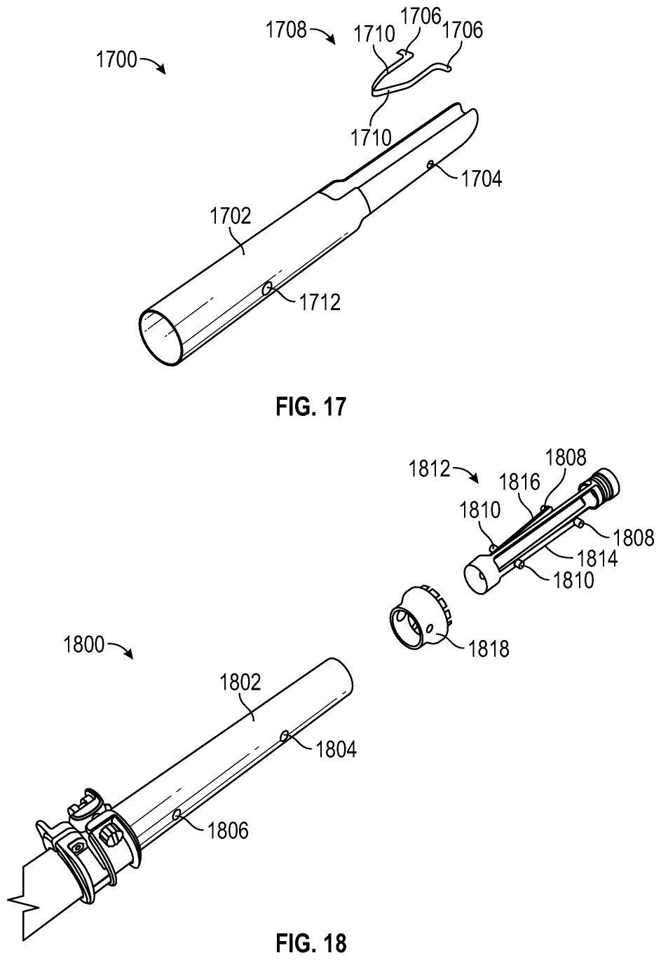

Turning now to FIG. 17, a schematic illustration of a connection assembly 1700 for use with extendable cleaning tools in accordance with an embodiment of the present disclosure are shown. The connection assembly 1700 provides for one mechanism that can be employed with embodiments of the present disclosure to join different pole elements together. As shown in FIG. 17, a pole extension adapter 1702 is shown. The pole extension adapter 1702 has a pin aperture 1704 for receiving a detent pin 1706. The detent pin 1706 is part of a pin connector 1708, which includes two detent pins 1706, as shown. The pin connector 1708, in this embodiment, is arranged as a V-spring such that the detent pins 1706 are arranged at the ends of connector arms 1710 and are biased outward from the center of the V-shape. The detent pins 1706 are configured to pass through respective pin apertures 1704 when the pin connector 1708 is placed within an interior of the pole extension adapter 1702 (or other part of an extendable cleaning tool). The detent pins 1706 may then engage with apertures of another pole element, base, connector, or the like to join the two (or more) components/elements together, as will be appreciated by those of skill in the art. As shown, the pole extension adapter 1702 has a second pin aperture 1712. The second pin aperture 1712 may be configured to receive a detent pin of a second pin connector to enable joining of the pole extension adapter 1702 with another component, such as an anti-rotation member or another pole element. Although shown in a V-shaped configuration, those of skill in the art will appreciate that pin connectors with biased detent pins may be configured and arrange with difference structures, including, but not limited to, axial spring configurations, single detent pins with an internal spring and integrally installed into a component of the extendable pole, or the like.

Turning to FIG. 18, a schematic illustration of a connection assembly 1800 for use with extendable cleaning tools in accordance with an embodiment of the present disclosure are shown. The connection assembly 1800 provides for an alternative mechanism that can be employed with embodiments of the present disclosure to join different pole elements together. As shown in FIG. 18, a pole element 1802 is shown. The pole element 1802 has two pin apertures 1804, 1806 for receiving respective detent pins 1808, 1810. The detent pins 1808, 1810 are part of a pin connector 1808. In this embodiment, the pin connector 1812 has two arms 1814, 1816, with two detent pins 1808, 1810 on each arm 1814, 1816. The detent pins 1808, 1810 are configured to pass through respective pin apertures 1804, 1806 when the pin connector 1812 is placed within an interior of the pole element 1802 (or other part of an extendable cleaning tool). The detent pins 1808, 1810 may then engage with apertures of another pole element, base, connector, or the like to join the two (or more) components/elements together, as will be appreciated by those of skill in the art. In this embodiment, the pole element 1802 has two pin apertures 1804, 1806, with the pin apertures 1804, 1806 arranged to receive the detent pins 1808, 1810, respectively. In this illustrative embodiment, a first set of detent pins 1808 may engage through a first set of pin apertures 1804 to enable engagement with a base or other pole element (see, e.g., FIGS. 16A-16C), which a second set of detent pins 1810 may engage through a second set of pin apertures 1806 to enable engagement with an anti-rotation member 1818. Although shown with a specific configuration, the pin connector 1812 shown in FIG. 18 may be used with various different connections between pole elements and/or pole elements with other components, as shown and described herein. The dual-pin set configuration of FIG. 18 can provide for improved anti-rotation between joined components. Further, the dual-pin set configuration may provide for improved engagement between the pin connectors and the element to which they engage. The two arms 1814, 1816 may provide for increased resistance and/or spring constant to ensure that the detent pins do not disengage unexpectedly.

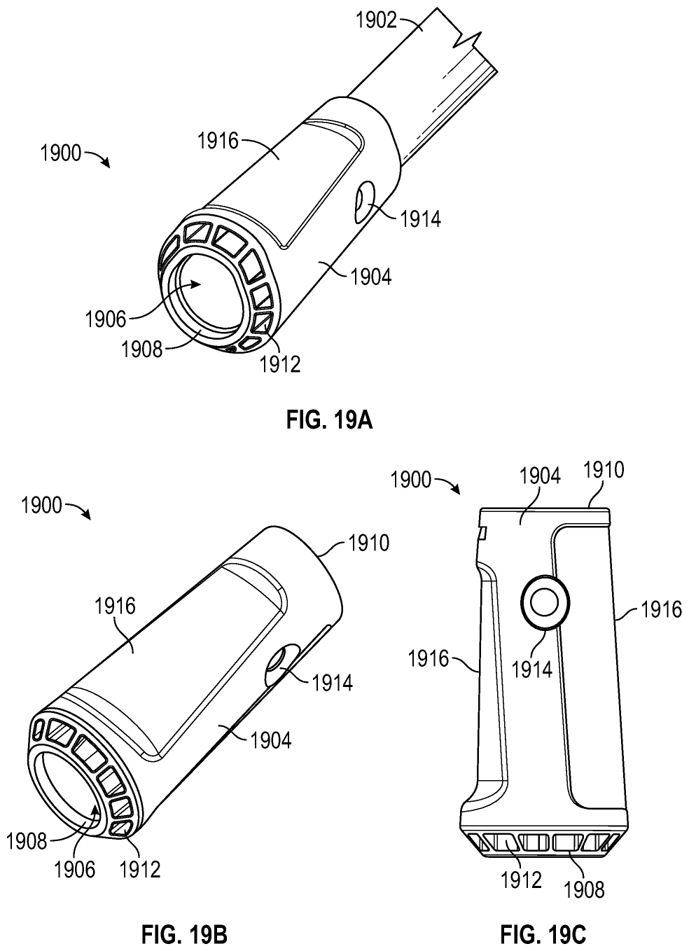

Turning now to FIGS. 19A-19C, schematic illustrations of a handle 1900 for use with extendable cleaning tools in accordance with an embodiment of the present disclosure are shown. The handle 1900 may be configured to attach to a pole element 1902, as shown in FIG. 19A. The handle 1900 has a handle body 1904 that defines a non-circular bore 1906 therethrough that extends from a first end 1908 to a second end 1910 of the handle body 1904. At the first end 1908 of the handle body 1904, the handle 1900 includes recesses 1912 configured to receive protrusions of an anti-rotation member, such as shown and described above. In accordance with some embodiments, the handle 1900 may be a base, as described above. The handle body 1904 may include one or more pin apertures 1914 that may be configured to receive detent pins or the like, as described above, to enable secure and non-rotating connection to attach the handle 1900 to the pole element 1902 (or other pole elements). The handle 1900 may also have one or more grip surfaces 1916 configured to enabling a user to grip, hold, and use an extendable pole that includes such handles 1900.

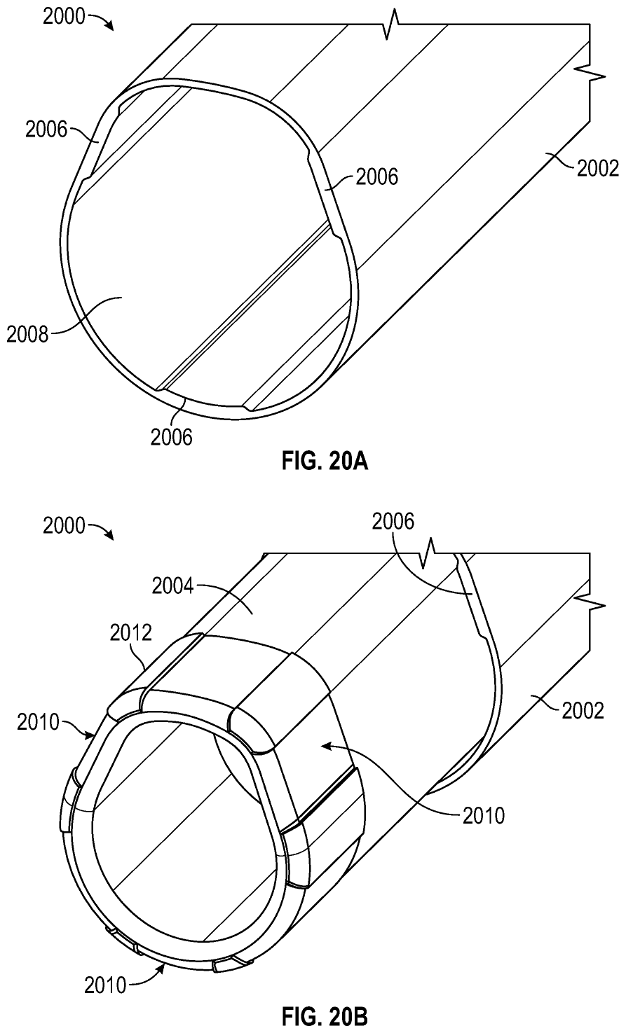

Turning now to FIGS. 20A-20B, schematic illustrations of an anti-rotation configuration 2000 in accordance with an embodiment of the present disclosure is shown. The anti-rotation configuration 2000 is defined between a first pole element 2002 and a second pole element 2004. As shown, in this configuration, the second pole element 2004 is configured to fit within the first pole element 2002. Relative rotation between the first pole element 2002 and the second pole element 2004 may be prevented, in part, by the non-circular shape of the first and second pole elements 2002, 2004. The two pole elements 2002, 2004 have substantially the same geometric profile (of differing sizes) such that the second pole element 2004 can slide into and relative to the first pole element 2002 in an axial direction along each of the first and second pole elements 2002, 2004.

The first pole element 2002 includes one or more anti-rotation ribs 2006 arranged on an interior surface 2008 of the first pole element 2002. The anti-rotation ribs 2006 may be arranged only proximate an end of the first pole element 2002 or may extend along a partial or full length of the first pole element 2002. The anti-rotation ribs 2006 of the first pole element 2002 are configured to engage with anti-rotation recesses 2010 of the second pole element 2004. The anti-rotation recesses 2010 may be formed on the exterior of the second pole element 2004 and/or on an anti-rotation plug 2012, as illustratively shown in FIG. 20B. In some embodiments, the anti-rotation plug 2012 may be a separately formed structure that is attached to the second pole element 2004. In other embodiments, the anti-rotation plug 2012 may be integrally formed or part of the second pole element 2004. The anti-rotation configuration 2000 of FIGS. 20A-20B may be employed to prevent twisting between adjacent pole elements due to a gap or clearance between the pole elements when assembled (i.e., one pole element within another pole element). Although shown with three anti-rotation ribs 2006 and three corresponding anti-rotation recesses 2010, those of skill in the art will appreciate that any number of anti-rotation features may be used without departing from the scope of the present disclosure (e.g., none, one, more than one, etc.). Further, in some embodiments, each set of nested pole elements may include such anti-rotation configurations/features. In other embodiments, such anti-rotation configurations/features may be required for the pole elements farthest from the use, to provide additional anti-rotation/anti-twist to the fully extended pole elements. Other configurations or arrangements of such anti-rotation configurations are possible without departing from the scope of the present disclosure, and thus the present illustrative embodiments are not intended to be limiting.

Advantageously, embodiments described herein provide improved extendable cleaning tools and aspects related thereto. In accordance with some embodiments, advantageously, a non-circular pole is provided to enable ease of use, handling, and reductions in required forces for secure engagement, as described above. Further, in accordance with some embodiments, pole extension adapters are provided which enable ease of assembly for extended extension poles. Such pole extension adapters also include channels for directing a hose from an external location to be internal to the pole, without unnecessary connectors and/or adapters. Further, such pole extension adapters may enable use of different or user-selected hoses and tubes, and not specific pre-set design or configuration is required.

Furthermore, in accordance with some embodiments, improved clamps for extendable poles are provided. The clamps operate with non-circular poles and provide for gripping surfaces and materials that lessen forces applied to the poles, thus improving engagement while at the same time reducing engagement forces. Moreover, advantageously, the clamps may include levers that are switchable or changeable with respect to orientation about the clamp, thus allowing for left- or right-handed use. The clamps may further include a biasing element that helps or aids opening/release of the clamps.

Additionally, in accordance with some embodiments, adjustable and customizable working head assemblies are provided that enable use with both circular and non-circular poles. Further, such working head assemblies may be adjustable in length and degrees of rotation and/or adjustment. Such working head assemblies can provide pivot rotations at joints or connection, rotation about a tool or head axis, and/or adjustments of a head about a connector rotational axis. As such, in accordance with some embodiments, at least three degrees of adjustment may be achieved using working head assemblies as described herein.

The use of the terms “a,” “an,” “the,” and similar references in the context of description (especially in the context of the following claims) are to be construed to cover both the singular and the plural, unless otherwise indicated herein or specifically contradicted by context. The modifiers “about” and “substantially,” used in connection with a quantity, are inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An extendable cleaning tool comprising:
a plurality of pole elements, wherein the plurality of pole elements include an innermost pole element and an outermost pole element, wherein the innermost pole element is moveable relative to the outermost pole element in an axial direction and the innermost pole element and the outermost pole element are not rotatable relative to each other;
a clamp arranged at an end of the outermost pole element and configured to selectively engage with a pole element of the plurality of pole elements arranged within the outermost pole element; and
a working head assembly attached to an end of the innermost pole element.

2. The extendable cleaning tool of claim 1, wherein the working head assembly includes a pole connector configured to engage with the innermost pole element and a head connector configured to engage with a working head.

3. The extendable cleaning tool of claim 3, wherein the working head is a water-fed working head.

4. The extendable cleaning tool of claim 3, wherein the pole connector includes a circular connector and a non-circular connector.

5. The extendable cleaning tool of claim 3, wherein the head connector includes a pivot portion and a connector portion, wherein the pivot portion is configured to pivotally attach to the innermost pole element and the connector portion is configured to attach to a working head.

6. The extendable cleaning tool of claim 5, wherein the pivot portion and the connector portion are releasably attachable with each other.

7. The extendable cleaning tool of claim 5, wherein the connector portion is configured to be rotated relative to the pivot portion about a head connector axis.

8. The extendable cleaning tool of claim 7, wherein the connector portion includes a polygonal bore and the pivot portion includes a polygonal base, wherein the polygonal bore and the polygonal base are configured to enable rotation about the head connector axis in a fixed manner.

9. The extendable cleaning tool of claim 5, wherein the connector portion includes a connector rotational axis such that an attached working head is rotatable about the connector rotational axis.

10. The extendable cleaning tool of claim 9, wherein the connector portion includes a locking element configured to secure the attached working head about the connector rotational axis.

11. The extendable cleaning tool of claim 1, wherein the clamp includes a lever and an adjustment knob that are engageable and configured to open or close the clamp from engagement with the pole element of the plurality of pole elements arranged within the outermost pole element.

12. The extendable cleaning tool of claim 1, wherein the clamp defines a bore therethrough with a first portion configured to engage the outermost pole and a second portion configured to selectively engage with the pole element of the plurality of pole elements arranged within the outermost pole element.

13. The extendable cleaning tool of claim 1, wherein the clamp includes at least one pole grip, the pole grip being formed of thermoplastic rubber or thermoplastic elastomer.

14. The extendable cleaning tool of claim 1, wherein each pole element of the plurality of pole elements has a non-circular cross-sectional geometry.

15. The extendable cleaning tool of claim 1, wherein each pole element of the plurality of pole elements includes at least two lobes, wherein each lobe is a continuous curved structure of the material of the respective pole element having a constant radius of curvature.

16. The extendable cleaning tool of claim 1, wherein each pole element of the plurality of pole elements includes three lobes, wherein each lobe is a continuous curved structure of the material of the respective pole element having a constant radius of curvature.

17. The extendable cleaning tool of claim 16, wherein two adjacent lobes of the three lobes are connected by an intermediate section, wherein the intermediate section has a different curvature than either of the two connected lobes.

18. The extendable cleaning tool of claim 1, further comprising a pole extension adapter configured to attach to the outermost pole at an end opposite the end engageable with the working head assembly, wherein the pole extension adapter is configured to connect at least one additional pole element to the outermost pole.

19. The extendable cleaning tool of claim 18, wherein the pole extension adapter defines a channel configured to allow a hose to pass from an exterior area to within the outermost pole element at a location between the outermost pole element and the at least one additional pole element.

20. The extendable cleaning tool of claim 1, wherein the working head assembly includes a pole connector, a first extension element, and a head connector, wherein the first extension element is connected between the pole connector and the head connector.
